(19) United States
(12) Patent Application Publication
(10) Pub. No.: US 2026/0289433 A1
(43) Pub. Date: Sep. 24, 2026

(54) SYSTEM

(71) Applicant: SoftBank Group Corp., Tokyo (JP)

(72) Inventor: Hiroshi SHIRAI, Tokyo (JP)

(73) Assignee: SoftBank Group Corp., Tokyo (JP)

(21) Appl. No.: 19/567,292

(22) Filed: Mar. 16, 2026

(30) Foreign Application Priority Data
Mar. 19, 2025 (JP) 2025-045245

(51) Int. Cl. G06Q 10/02; G06F 40/10; G06F 40/205; G06F 40/30; G06N 3/0475; G06Q 10/04; G06V 40/16

(52) U.S. Cl. CPC G06Q 10/021; G06F 40/10; G06F 40/205; G06F 40/30; G06N 3/0475; G06Q 10/04; G06V 40/174

(57) ABSTRACT

A system includes a processor that is configured to receive, from a user, travel image information, budget information, and emotion information, analyze the received information and generate a prompt for instructing a generative artificial intelligence model to select an accommodation facility, a transportation means, and a sightseeing place, and perform bulk reservation of the selected accommodation facility and the selected transportation means via a reservation system.

### CROSS-REFERENCE TO RELATED APPLICATION

This application is based on and claims priority under 35 USC 119 from Japanese Patent Application No. 2025-045245 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional travel planning systems generally require a user to manually input a large amount of structured information, such as desired destinations, specific dates, transportation modes, and accommodation conditions. Even when recommendation engines are provided, these systems typically depend on fixed rule-based logic or predefined templates and are not capable of flexibly interpreting an abstract travel image expressed in natural language by the user. As a result, the user must iteratively refine search conditions and individually select and reserve an accommodation facility and multiple transportation options, which imposes a significant operational burden on the user.

In addition, conventional systems do not sufficiently consider the emotional state of the user. Even if preference information such as “likes hot springs” or “prefers nature” is registered in advance, changes in the user's current mood or emotional condition are not dynamically reflected in the generated travel plan. Consequently, the proposed travel plan may not match the user's real-time emotional needs, and the user's satisfaction with the travel experience may be reduced.
Furthermore, because reservations for accommodations and transportation means are often handled separately across different systems or services, the user must confirm availability and execute reservations item by item. This fragmentation increases the risk of inconsistency between the travel plan and the actually reserved elements, such as mismatched dates or times, and complicates modifications or cancellations. Therefore, there is a need for a system that can: (i) interpret a user's abstract travel image and budget information expressed in natural language, (ii) take into account the user's emotional state, and (iii) automatically generate and adjust a travel plan while performing bulk reservations of an accommodation facility and transportation means in an integrated manner.

### SUMMARY

In order to solve at least part of the above-described problems, according to one aspect of the present invention, there is provided a system comprising a processor, wherein the processor is configured to receive, from a user, travel image information, budget information, and emotion information, analyze the received information, and generate a prompt for instructing a generative artificial intelligence model to select an accommodation facility, a transportation means, and a sightseeing place. By using a generative artificial intelligence model controlled through such a prompt, the system can flexibly interpret an abstract travel image expressed in natural language together with budget constraints, and can automatically derive a set of candidate travel components, including the accommodation facility, the transportation means, and the sightseeing place, that are consistent with the user's intent.

The processor is further configured to perform bulk reservation of the selected accommodation facility and the selected transportation means via a reservation system. By integrating reservation operations for multiple elements, the system can automatically ensure consistency between the generated travel plan and the actually reserved items, thereby reducing the burden on the user to check and individually book each component and minimizing the risk of date or time mismatches.

In addition, the processor is configured to analyze an emotion of the user based on the emotion information and dynamically adjust a travel plan based on the analyzed emotion. For example, the processor can modify the selection of the accommodation facility, the transportation means, and the sightseeing place, or re-generate a prompt for the generative artificial intelligence model, in accordance with the user's current emotional state, such as feeling tired, excited, or stressed. As a result, the system can provide a travel plan that better matches the user's real-time emotional needs and can enhance the user's satisfaction. Furthermore, the processor is configured to present a generated travel plan to the user visually or aurally. By providing the travel plan in a visual format through a display or in an aural format through a speaker or voice interface, the system allows the user to easily understand and confirm the proposed itinerary and the result of the bulk reservations, and to interactively request modifications if necessary. Through these combined means, the present invention enables an integrated travel planning and reservation system that interprets natural language travel images, respects budget constraints, reflects emotional conditions, and automatically executes bulk reservations of travel components.

The term “system” refers to an arrangement of one or more hardware components and software modules that collectively execute processing for travel planning and reservation as described in the present specification.

The term “processor” refers to a hardware device, such as a central processing unit (CPU), a graphics processing unit (GPU), a microcontroller, or any combination thereof, that executes computer-readable instructions to perform the functions described in the present specification.
The term “travel image information” refers to information representing a user's intended travel concept or image, which may include, for example, desired atmosphere, style, qualitative preferences, or abstract requirements for a trip, and which can be expressed in natural language input, textual input, or voice input.
The term “budget information” refers to information indicating a monetary constraint or range specified by a user for a trip, including, for example, a maximum allowable amount or a target amount encompassing at least accommodation costs and transportation costs. The term “emotion information” refers to information representing an emotional state or mood of a user, which may be obtained from explicit user input, sensor data, behavioral analysis, or any combination thereof, and which is used for deriving or estimating the user's current emotional condition.
The term “generative artificial intelligence model” refers to a machine learning model that is capable of generating content or outputs, such as text, recommendations, or structured data, based on input data and learned parameters, and includes, for example, a large language model, a generative neural network, or a similar generative model.
The term “prompt” refers to data, including text or structured information, that is generated by the processor and provided as input to the generative artificial intelligence model in order to instruct the generative artificial intelligence model to perform selection or generation of at least an accommodation facility, a transportation means, and a sightseeing place.
The term “accommodation facility” refers to any facility that provides lodging services to a user, including, for example, hotels, inns, hostels, guesthouses, resorts, ryokan, or similar establishments.
The term “transportation means” refers to any mode or service for transporting a user between locations, including, for example, trains, buses, airplanes, ships, taxis, ride-sharing services, or rental cars.
The term “sightseeing place” refers to any location or facility that can be visited by a user for tourism, leisure, or cultural experience, including, for example, tourist attractions, landmarks, museums, parks, temples, shrines, and entertainment facilities.
The term “reservation system” refers to a system, service, or interface, including external services, through which bookings or reservations for at least an accommodation facility and a transportation means can be made, modified, or canceled electronically.
The term “bulk reservation” refers to processing in which reservations for a plurality of travel components, including at least an accommodation facility and a transportation means, are performed in an integrated manner based on a generated travel plan, without requiring the user to individually execute separate reservation operations for each component.
The term “travel plan” refers to information representing at least a proposed or determined itinerary for a user, including one or more of a selected accommodation facility, selected transportation means, selected sightseeing places, schedules, dates, times, and cost-related information.
The term “visually” refers to a mode of presentation in which information is output in a visual form, such as on a display, monitor, or graphical user interface, allowing the user to perceive the travel plan through sight.
The term “aurally” refers to a mode of presentation in which information is output in an audio form, such as through a speaker, headphones, or synthesized speech, allowing the user to perceive the travel plan through hearing.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### FIRST EXEMPLARY EMBODIMENT

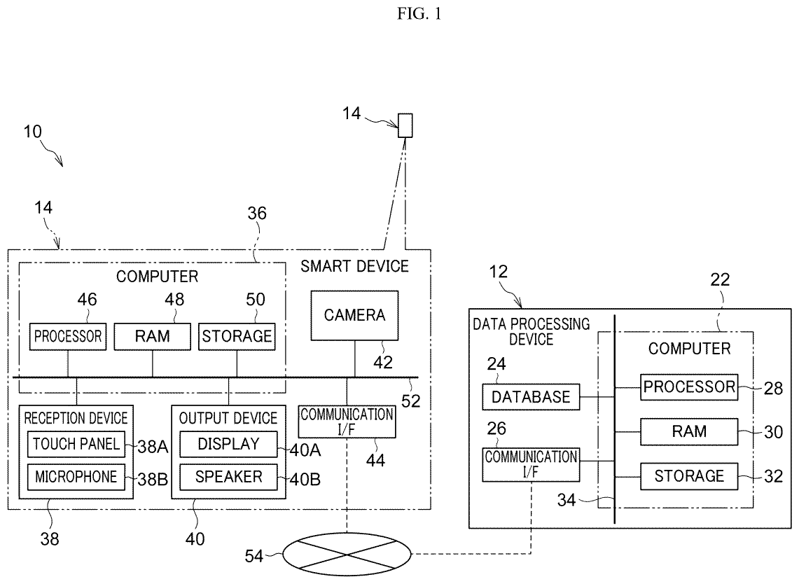

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

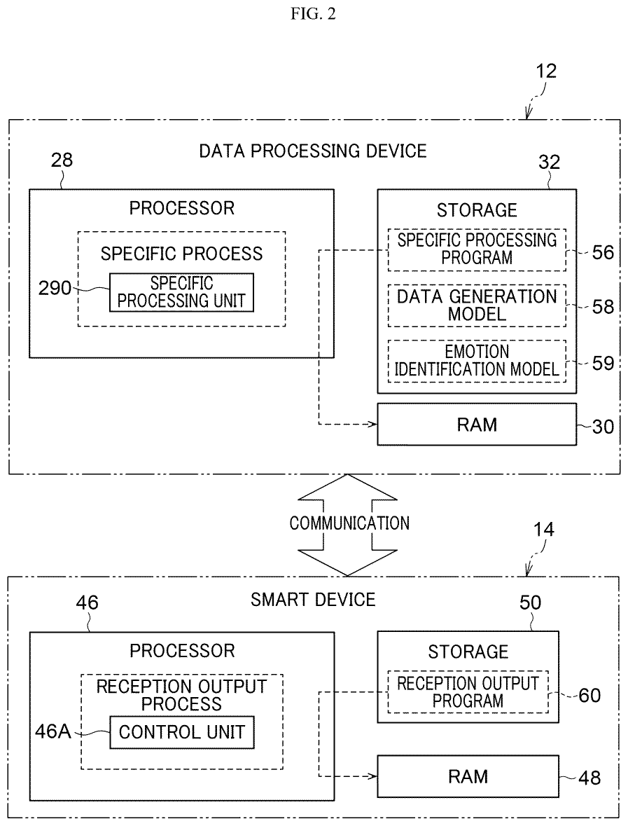

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented travel planning systems typically rely on rule-based engines or static search queries that separately handle lodging search, transportation search, and sightseeing recommendation. In such systems, a processor generally receives structured parameters, such as destination, dates, and budget, and then executes independent search routines against predetermined databases or reservation systems. This architecture suffers from several technical limitations.

First, the processor often performs repetitive, fragmented search and filtering operations across heterogeneous external reservation systems. Each subsystem independently retrieves candidates and then passes results to a central component for simple aggregation. As a result, the system performs duplicative network access and filtering logic, causing increased processor load, network bandwidth consumption, and response time, especially when the user requirements are ambiguous or expressed in natural language rather than in well-structured form.
Second, existing systems are not optimized to programmatically interpret a user's tourism “image” expressed in free-form natural language together with emotion-related information. Without a mechanism to transform such unstructured information into a unified machine-understandable representation, the processor must either ignore much of the useful contextual information or rely on ad hoc keyword matching. This leads to technically inefficient query generation, low-quality candidate selection, and an increased number of user-system interaction cycles to refine the search, which in turn further increases processing load and latency.
Third, many systems do not integrate a generative AI model as a front-end planning engine that can pre-structure the search space. Without such a model and an optimized prompt sentence, the processor must directly perform broad database queries and complex combinatorial evaluations over large candidate sets of accommodations, transportation options, and sightseeing spots. This results in unnecessary computation and memory usage because the system repeatedly evaluates candidates that will ultimately be discarded. Fourth, existing systems rarely provide an integrated mechanism for verifying and normalizing AI-generated candidates with live availability and pricing data from external reservation systems, followed by coordinated bulk reservation processing. In typical architectures, validation, plan adjustment, and reservation are implemented as loosely coupled processes, often requiring intermediate manual intervention or multiple round trips between user and server. This fragmented pipeline leads to inconsistent data states, potential reservation conflicts, and inefficient use of external reservation interfaces.
Fifth, there is no standardized server-side mechanism that dynamically adjusts an itinerary according to a user's emotional state as interpreted from the input and AI-generated suggestions, while simultaneously maintaining consistency with budget, schedule, and real-time availability constraints. As a result, even if emotional preferences are captured, they are generally not used in a computationally efficient way to guide candidate pruning and itinerary restructuring.

Accordingly, there is a need for an improved computer-implemented technique in which a processor: (i) acquires comprehensive tourism request information including a tourism image, budget information, period information, departure location information, desired activity information, and emotion information; (ii) transforms this information into an optimized prompt sentence; (iii) cooperates with a generative AI model to generate structured tourism candidate information; (iv) validates and refines the candidate information using external reservation systems; and (v) performs coordinated bulk reservation and structured output generation. Such a technique should reduce redundant computation, minimize network traffic with external systems, and improve the overall technical performance and responsiveness of the travel planning platform, while enabling dynamic itinerary adjustment based on an inferred emotional state.

The specific processing by the specific processing unit 290 of the data processing device 12 in Example 1 is realized by the following means.

The present invention provides a server comprising a processor and a communication interface, the processor being configured to acquire, via the communication interface, tourism request information from a user-operated information terminal, the tourism request information including at least a tourism image expressed in natural language, budget information, period information, departure location information, desired activity information, and emotion information; to analyze the acquired tourism request information to extract a parameter set representing at least a departure location, a budget range, a travel period, a travel purpose, desired activities, and an emotional state of the user, and to generate a prompt sentence that embeds the parameter set and the tourism request information; to input the prompt sentence into a generative AI model that outputs structured tourism candidate information including at least accommodation candidates, transportation candidates, and sightseeing candidates, thereby offloading from the server side a portion of the combinatorial candidate generation processing to the generative AI model; to perform, based on the structured tourism candidate information, search processing for real accommodations and real transportation options via an external reservation information processing device by using a standardized communication interface, to acquire vacancy information and fee information for the real accommodations and transportation options, and to verify the structured tourism candidate information based on at least the budget range and the travel period to generate tourism plan information; to perform coordinated bulk reservation processing by transmitting, for accommodations and transportation options included in the tourism plan information, reservation request information in bulk via the standardized communication interface to the external reservation information processing device, acquiring reservation confirmation information in response to the bulk transmission, and storing the reservation confirmation information in association with the tourism plan information; to dynamically adjust at least one of time allocation, types of sightseeing candidates, comfort level of transportation candidates, and cost allocation based on analysis of the emotional state of the user derived from the emotion information and the tourism candidate information, thereby regenerating updated tourism plan information that remains consistent with budget and availability constraints; and to generate display data including at least time-series itinerary information, cost information, and reservation identification information based on the tourism plan information and the reservation confirmation information, and to transmit the display data to the information terminal as visual output data and/or audio output data. This enables the server to transform unstructured tourism and emotion information into a machine-optimized prompt sentence for a generative AI model, to narrow the search space before accessing external reservation systems, to reduce redundant computation and network traffic through structured verification and bulk reservation processing, and to provide dynamically adjusted itineraries that are technically consistent with real-time availability, thereby improving the overall performance, scalability, and responsiveness of the computer-implemented travel planning system.

The term “system” refers to an arrangement including at least one processor and at least one communication interface configured to execute computer-implemented processing described in the claims.

The term “processor” refers to a hardware-based processing unit, such as a central processing unit or a dedicated computation circuit, configured to execute instructions stored in a memory to perform the functions described in the claims.
The term “communication interface” refers to a hardware and software combination that enables data exchange between the system and external devices or networks, including wired and wireless communication mechanisms.
The term “information terminal” refers to an electronic device operated by a user, such as a computing device with an input/output interface, configured to transmit data to and receive data from the system.
The term “user” refers to a human operator who interacts with the information terminal to input tourism-related information and to receive a tourism plan.
The term “tourism request information” refers to data transmitted from the information terminal to the system, including at least a tourism image, budget information, period information, departure location information, desired activity information, and emotion information.
The term “tourism image” refers to unstructured or semi-structured information describing a desired travel scenario, including user preferences, objectives, impressions, or expectations expressed in natural language.
The term “budget information” refers to data indicating a monetary constraint or range associated with a planned travel, including at least a total budget and optionally partial budgets for different expense categories.
The term “period information” refers to data indicating a travel duration, including at least start date, end date, or length of stay for a planned travel.
The term “departure location information” refers to data indicating a geographic origin or starting point of a planned travel, including at least a city, region, or transportation hub.
The term “desired activity information” refers to data specifying types of activities that a user wishes to experience during a planned travel, such as leisure, sightseeing, cultural, or relaxation activities.
The term “emotion information” refers to data indicating a user's emotional state, preference, or mood related to a planned travel, explicitly input by the user or implicitly derivable from the user's expressions.
The term “parameter set” refers to a structured collection of values derived from the tourism request information, representing at least a departure location, budget range, travel period, travel purpose, desired activities, and emotional state.
The term “prompt sentence” refers to a machine-readable instruction string constructed by the processor, embedding at least the parameter set and tourism request information, and formatted for input to a generative AI model.
The term “generative AI model” refers to a data-driven model trained on large-scale data, such as a generative language model, configured to generate structured or unstructured output in response to an input prompt sentence.
The term “tourism candidate information” refers to structured data generated by the generative AI model, including at least one accommodation candidate, at least one transportation candidate, and at least one sightseeing candidate.
The term “accommodation candidate” refers to an item included in the tourism candidate information that represents a potential lodging option for a planned travel.
The term “transportation candidate” refers to an item included in the tourism candidate information that represents a potential movement option between locations for a planned travel.
The term “sightseeing candidate” refers to an item included in the tourism candidate information that represents a potential place or activity to be visited or experienced during a planned travel.
The term “external reservation information processing device” refers to an external computing system that provides access to reservation-related data, including availability and pricing, for accommodations and transportation via a communication interface.
The term “communication interface provided by an external reservation information processing device” refers to a network-accessible interface, such as an application programming interface, enabling reservation-related queries and reservation operations.
The term “real accommodations” refers to actual lodging facilities available for reservation, as managed by the external reservation information processing device.
The term “real transportation options” refers to actual transportation services available for reservation, as managed by the external reservation information processing device.
The term “vacancy information” refers to data indicating availability status of real accommodations or transportation options for a given period or schedule.
The term “fee information” refers to data indicating prices, fares, or costs associated with real accommodations or transportation options.
The term “budget range” refers to a lower and/or upper bound of permissible total or partial travel-related expenses derived from budget information.
The term “tourism plan information” refers to structured data representing a composed travel plan, including at least selected accommodations, transportation options, sightseeing items, schedule, and cost information.
The term “reservation request information” refers to data transmitted from the system to the external reservation information processing device to request the creation of reservations for accommodations or transportation options.
The term “bulk transmission” refers to a processing mode in which multiple reservation request information items are transmitted as part of a coordinated operation rather than as isolated individual requests.
The term “reservation confirmation information” refers to data returned from the external reservation information processing device indicating successful creation or status of a reservation, including at least reservation identifiers and relevant details.
The term “time-series itinerary information” refers to data representing an ordered sequence of travel-related events over time, including at least check-in times, check-out times, departures, arrivals, and scheduled visits.
The term “cost information” refers to data indicating monetary amounts associated with elements of the tourism plan information, including at least subtotals and total costs.
The term “reservation identification information” refers to identifiers or codes associated with reservations created for accommodations or transportation options, enabling subsequent reference or management.
The term “display data” refers to data formatted for presentation on the information terminal, including structured information suitable for graphical or auditory output.
The term “emotional state” refers to a representation of the user's mood or preference inferred or derived from the emotion information and optionally from the tourism candidate information.
The term “time allocation” refers to a distribution of available time among different elements of a travel plan, such as stays at accommodations, travel segments, and sightseeing activities.
The term “types of sightseeing candidates” refers to categories or classes of sightseeing items, such as cultural, natural, recreational, or gastronomic activities, considered for inclusion in a tourism plan.
The term “comfort level of transportation candidates” refers to a characteristic of transportation options indicating ease or pleasantness of travel, which may be based on seat class, travel duration, number of transfers, or similar criteria.
The term “cost allocation” refers to distribution of budget among different components of a travel plan, such as accommodations, transportation, and sightseeing.
The term “visual output data” refers to data formatted to be rendered as images, text, or graphical user interface elements on a display of the information terminal.
The term “audio output data” refers to data formatted to be converted into sound or speech and output through an audio interface of the information terminal.

In the following embodiments, a “server” denotes an information processing apparatus including at least one processor, a memory, a storage device, and a communication interface connected to one or more networks. A “terminal” denotes a user-operated computing device such as a smartphone, tablet, or personal computer including at least a display, an input interface, and a communication interface. A “user” denotes a human operator who interacts with the terminal.

### A. Overall Configuration

The server includes at least a central processing unit (CPU), a main memory (DRAM), a non-volatile storage device (for example, a solid-state drive), a network interface controller (NIC), and, in some embodiments, one or more graphics processing units (GPU) for acceleration of a generative AI model. The server executes an operating system such as a general-purpose server operating system and runs server software including a web server module, an application server module, a database management system, and an AI inference module.
The terminal includes at least a processor, a memory, an input/output interface, and a wireless or wired communication module. The terminal executes a client application such as a web browser or a native application that communicates with the server via a secure protocol such as HTTPS.
The server and the terminal exchange data over a communication network such as the Internet. The server manages a database that stores tourism request information, tourism candidate information, tourism plan information, and reservation-related information in structured data formats.

### B. Data Structures and Storage

The server stores tourism request information in a relational database or document store. In one embodiment, the server uses a relational database management system, and defines a table “tourism_requests” having fields such as:
request_id (primary key),
user_id,
tourism_image_text,
budget_min,
budget_max,
period_start,
period_end,
departure_location_code,
desired_activity_codes,
emotion_raw_text,
emotion_label,
created_at,
updated_at.

The server stores tourism candidate information produced by a generative AI model in another table or collection, for example “tourism_candidates”, including fields such as:
candidate_id,
request_id,
accommodation_candidates (serialized structured data),
transportation_candidates (serialized structured data),
sightseeing_candidates (serialized structured data),
estimated_total_cost,
estimated_total_time,
model_version,
prompt_sentence_text.
   The server stores final tourism plan information in a table “tourism_plans” including:
plan_id,
request_id,
selected_accommodations (structured data),
selected_transportation (structured data),
selected_sightseeing (structured data),
itinerary_data (time-series structure),
total_cost,
comfort_score,
emotion_alignment_score.
   The server stores reservation confirmation information in tables such as “reservations”, “hotel_reservations”, and “transport_reservations” containing reservation identifiers, external system identifiers, confirmation timestamps, and cancellation policies.
   By structuring data in this manner, the server can perform efficient indexing, filtering, and joins, thereby reducing processing time and improving data retrieval performance compared with ad hoc or unstructured storage.

### C. Analysis of Tourism Request Information and Construction of Prompt Sentence

The server receives tourism request information from the terminal as structured data including at least a free-text tourism image, budget information, period information, departure location information, desired activity information, and emotion information. The server stores this information and performs analysis using a combination of deterministic algorithms and machine-learned models.
The server first executes a natural language processing (NLP) module implemented in a general-purpose programming language and using an NLP library. The server tokenizes the tourism image text and the emotion raw text, performs part-of-speech tagging, and extracts named entities such as locations and dates. The server applies a set of domain-specific rules stored in configuration data, for example, rules that map phrases such as “one night and two days” to a specific period structure, and that map expressions such as “near the capital” to a region code.
The server additionally executes a classification model to derive an emotion label from the emotion raw text. In one embodiment, the server uses a neural network-based classifier implemented as a fine-tuned transformer encoder. The server inputs tokenized text with positional encodings into a stack of self-attention layers, obtains a contextual representation at a [CLS]-like token position, and applies a fully connected layer with a softmax output to generate probabilities over emotion categories (for example, “relaxed”, “adventurous”, “luxury-seeking”). The server selects the category with the maximum probability as the emotion label and stores this label in the tourism request record.
The server combines extracted features into a parameter set. This parameter set includes normalized departure location codes, budget range, period (start date and end date), inferred number of nights, desired activity categories, and the emotion label. The server represents this parameter set internally as a structured object, which is then serialized to text for inclusion in a prompt sentence.
The server constructs a prompt sentence for a generative AI model by concatenating template strings and the serialized parameter set. The server uses a predetermined prompt template stored in configuration data. The prompt template defines sections such as a role description, output format constraints, hard constraints (budget and period), and a quotation of the user's tourism image. The server embeds the parameter set to make explicit constraints that are not clearly stated in the natural language text.
For example, the server can generate a prompt sentence such as:
“You are a generative AI model specialized in domestic travel planning. Based on the following user requirements, generate an optimal tourism plan that includes accommodations, transportation, and sightseeing spots. The total cost of accommodations and transportation must be within 30,000 yen. The trip duration is one night and two days. The departure area is near a specified metropolitan region. The user wishes to enjoy hot springs in a relaxing way. Output your answer as structured text that clearly lists accommodation options, transportation options, and sightseeing spots, along with estimated prices. User tourism image: ‘I want a one-night, two-day trip near the city, with a total budget of 30,000 yen including transportation and accommodation, and I want to enjoy hot springs.’”
The server logs the prompt sentence together with the request identifier for traceability and for later analysis of system performance.
By explicitly encoding constraints and structured parameters in the prompt sentence, the server narrows the search space presented to the generative AI model and reduces the number of irrelevant or infeasible candidates returned. This reduces subsequent computation and network usage when the server validates the candidates.

### D. Generative AI Model Structure and Inference

The server invokes a generative AI model to generate tourism candidate information. In one embodiment, the server accesses a large language model via an external AI service. In another embodiment, the server hosts a generative AI model locally on GPUs.
The generative AI model is implemented as a transformer-based neural network. The server stores model parameters (weights) in persistent memory accessible by the AI inference module. The model includes an embedding layer that converts tokens to dense vectors, multiple transformer blocks each including multi-head self-attention layers and position-wise feed-forward networks, and an output projection layer that maps hidden states to vocabulary logits.
During inference, the server encodes the prompt sentence into tokens, passes these tokens through the transformer blocks, and generates output tokens sequentially using a decoding strategy such as greedy decoding or beam search, subject to constraints specified in the prompt. The server sets inference parameters such as temperature and maximum token length to balance determinism and diversity.
The server applies post-processing rules to the generated text to extract structured tourism candidate information. For example, the server identifies lines or sections indicating accommodation candidates, transportation candidates, and sightseeing candidates. The server uses regular expressions and pattern-matching rules driven by labels explicitly requested in the prompt sentence. In some embodiments, the server requests the model to output labeled sections such as “ACCOMMODATION: . . . ” or “TRANSPORTATION: . . . ” to simplify parsing.
The server then converts the parsed data into internal data structures representing candidate items, each with attributes such as name, location, estimated price, and time windows. The server calculates initial estimates for total cost and total travel time from these attributes. The server stores this tourism candidate information in the database with a reference to the prompt sentence and model version.
By offloading the combinatorial candidate generation to a transformer-based generative model that is conditioned by a structured prompt sentence, the server avoids exhaustive enumeration of combinations of accommodations, transportation, and sightseeing items from raw databases. This significantly reduces the computational burden on the server when exploring the space of potential itineraries.
E. Verification with External Reservation Systems and Plan Generation
The server verifies the AI-generated tourism candidate information using one or more external reservation information processing devices accessible through communication interfaces such as application programming interfaces (APIs). The server predefines adapter modules for each type of external reservation system. These adapter modules normalize outbound requests and inbound responses to a common internal representation.
For accommodation candidates, the server constructs search queries based on location, date, number of nights, and rough price range extracted from the tourism candidate information. The server calls the external system's search endpoint, receives a list of real accommodations with availability and precise prices, and matches them against the AI-suggested candidates. The server uses similarity metrics, such as token-based string similarity and geographic proximity, to associate generated candidates with actual accommodation records.
For transportation candidates, the server calls route search and fare calculation endpoints provided by transportation reservation systems. The server uses the departure and destination locations, desired departure windows, and transportation mode preferences (for example, train or bus) extracted from the tourism candidate information. The server receives route options including transfer points, travel time, and fares, and matches them with the AI-suggested routes.
The server constructs a set of candidate plans by combining associated accommodations and transportation options that are both available and within the budget range. The server calculates the actual total cost for each candidate plan by summing accommodation prices and transportation fares, and compares this total with the budget range derived from the tourism request information. The server eliminates candidate plans whose total cost exceeds the upper bound of the budget range or violates period constraints.
The server optimizes among remaining candidate plans using a scoring function. The scoring function can include weights for total cost, total travel time, comfort score derived from transportation attributes (for example, seat class, number of transfers), and emotion alignment score computed from the emotion label and the categories of sightseeing candidates. The server computes a scalar score for each candidate plan and selects one or more top-scoring plans as tourism plan information.
This approach, where the server performs heuristic scoring and structured verification on top of AI-generated candidates, improves computational efficiency compared with purely heuristic or rule-based systems that must search over raw databases without a pre-structured candidate set. The server reduces the number of network calls and database queries needed by focusing verification efforts on a smaller, more relevant candidate set produced by the generative AI model.

### F. Emotion-Based Dynamic Adjustment

The server uses the emotion label and extracted context to dynamically adjust tourism plan information. The server implements a set of adjustment rules that associate emotion categories with permissible ranges for time allocation, preferred categories of sightseeing items, and tolerance for transportation complexity. For example, for a “relaxed” emotion label, the server may reduce allowable total daily walking time, increase weight for accommodations with comfort-related ratings, and penalize routes with many transfers. The server computes additional metrics from candidate plans, such as cumulative walking distance estimated from location coordinates and average rating for selected accommodations and sightseeing items. The server then applies adjustment rules to filter and re-rank candidate plans. In some embodiments, the server triggers a secondary call to the generative AI model with a modified prompt sentence that explicitly encodes the inferred emotional state and refined constraints, thereby generating revised tourism candidate information.
For instance, the server can generate an updated prompt sentence:
“Based on the following initial plan suggestions and the user's relaxed mood, revise the tourism plan to reduce the number of transfers and to prioritize accommodations and sightseeing spots suitable for quiet relaxation. Maintain the total cost within 30,000 yen and keep the trip duration as one night and two days. Provide updated accommodations, transportation, and sightseeing spots with explanations of the changes.”
By iteratively combining rule-based adjustments and targeted generative AI refinement, the server achieves higher alignment between the tourism plan and the user's emotional state while maintaining budget and availability constraints. This processing is distinct from simple keyword filtering and represents a non-conventional cooperation between deterministic algorithms and a generative AI model to optimize plan quality and computational efficiency.

### G. Bulk Reservation and Data Flow Control

After selecting tourism plan information, the server executes bulk reservation processing. The server assembles a batch of reservation request information including at least one accommodation reservation request and at least one transportation reservation request. The server uses a transaction controller module that sequences the calls to external reservation systems and handles partial failure.

The server initiates reservations in an order determined by a configuration, for example, reserving accommodations first, then transportation. The server sends requests via the standardized communication interface, receives reservation confirmation information, and temporarily stores each confirmation in memory. If a critical reservation fails, the server can cancel previously created reservations by calling cancellation endpoints where supported, thus avoiding inconsistent states. The server then updates the tourism plan information with confirmed reservation identifiers and associated details, and stores the updated data in persistent storage.
By using bulk reservation processing with coordination logic, the server minimizes the number of separate network transactions, reduces overall reservation latency, and ensures consistency between stored tourism plan information and external reservation system state. This coordinated bulk processing yields a technical improvement over naive sequential reservation that would require the user to initiate and manage each reservation manually.

### H. Generation and Presentation of Display Data

The server generates display data from the confirmed tourism plan information and reservation confirmation information. The server transforms the itinerary_data structure into a time-series representation that can be rendered as a timeline or schedule by the terminal. The server also prepares cost breakdowns and reservation identification information for each component.
The server produces display data as structured messages that the terminal can parse to generate visual or audio output. For visual output, the server includes sufficient metadata such as date, time, location names, and reservation identifiers so that the terminal can draw cards, lists, or calendar entries. For audio output, the server can provide preformatted text suitable for text-to-speech conversion.
The terminal receives the display data and renders it on a screen or through speakers. The user views or listens to the itinerary, checks reservation details, and interacts with the terminal to confirm acceptance or request changes. When the user confirms, the terminal transmits a confirmation message to the server, and the server marks the corresponding tourism plan as confirmed, optionally triggering the generation of downloadable documents such as confirmation summaries.

### I. Technical Effects and Improvement of Computer Technology

The described embodiments improve computer technology in several respects. The server constructs a prompt sentence that encodes a parameter set derived from the tourism request information. By doing so, the server reduces ambiguity and guides the generative AI model to produce structured, constraint-aware tourism candidate information. This reduces the number of irrelevant candidates and therefore reduces the number of subsequent network calls to external reservation systems, leading to lower communication load and faster response times. The server uses a transformer-based generative AI model in combination with deterministic parsing and verification algorithms, rather than implementing all logic as traditional rule-based computations. The generative AI model performs high-dimensional mapping from unstructured natural language and emotion information to structured candidate space. This mapping is not a mere automation of manual human planning; instead, it leverages large-scale learned representations and attention-based architectures to infer candidate combinations that would be computationally expensive to derive solely with rule-based methods.
The server further improves computational efficiency by using a scoring function and emotion-based adjustment rules that operate on a limited candidate set generated by the AI model. The server thus avoids exhaustive enumeration over all combinations in large accommodation and transportation databases. The interleaving of AI generation and rule-based pruning constitutes a particular data processing architecture that enhances performance, scalability, and quality of results in comparison to conventional systems that treat these components independently.
The server also improves data management by storing intermediate artifacts such as prompt sentences, model versions, and candidate sets with explicit linkage to tourism request identifiers. This facilitates traceability, model evaluation, and iterative refinement, and allows the system to reuse learned patterns or prompts for similar future requests, thereby reducing average computation.
Because the described system specifically structures internal data, coordinates external reservation interfaces, and controls data flow through multiple modules in a non-conventional way, the embodiments provide concrete technical improvements to the operation of the server and networked computer systems, rather than merely implementing an abstract business method. The improvements include reduced communication overhead, reduced processing time, improved accuracy of plan feasibility, and robust handling of reservations across heterogeneous external systems.

### J. Variations and Alternative Embodiments

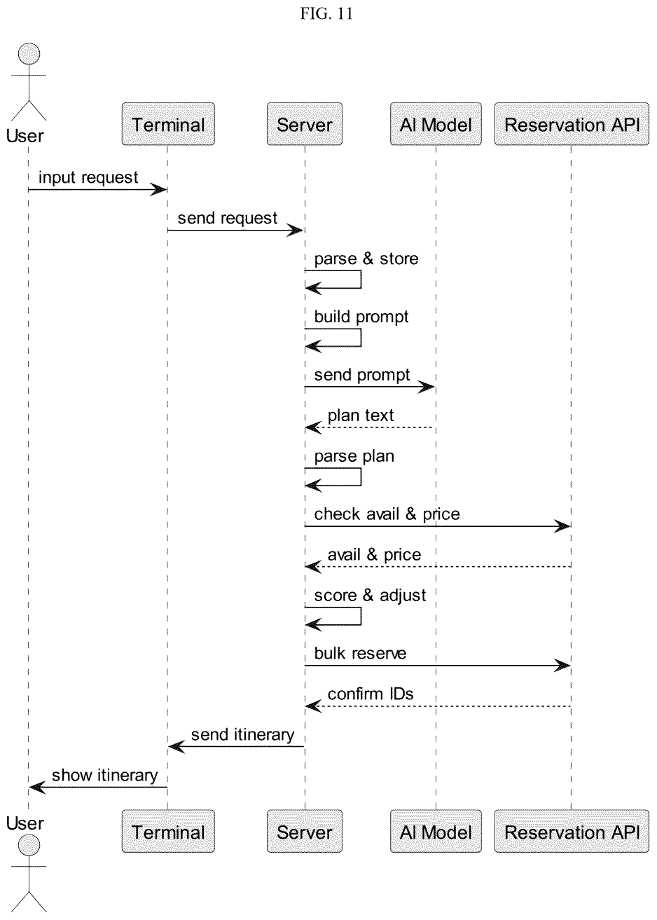

The server can be implemented as a single physical machine or as a distributed system comprising multiple nodes behind a load balancer. In a distributed embodiment, the AI inference module can run on a dedicated node equipped with GPUs, and the web application and database can run on separate nodes. The communication interface between modules can use internal remote procedure call mechanisms.
The generative AI model can be replaced with or supplemented by other model architectures, such as encoder-decoder transformers or recurrent neural networks, provided that they accept a prompt sentence and output structured or semi-structured text. The emotion classifier can be trained using supervised learning on labeled emotion datasets, optimized with a cross-entropy loss function and updated by gradient descent methods. The training can incorporate data augmentation techniques such as synonym replacement and back-translation to improve robustness.
The server can adjust its inference parameters adaptively based on statistics of previous calls, for example, by reducing output length when the generated text consistently exceeds a desired size, or by adjusting temperature to stabilize outputs. The server can also store typical prompt patterns and corresponding responses and reuse them as few-shot examples in future prompts to enhance accuracy.
The terminal can be implemented using different frameworks, such as a web-based interface or a native mobile application, as long as it sends and receives the specified structures. The visual rendering of display data can vary, but does not change the underlying technical processing on the server.
By these configurations and variations, the server, the terminal, and the user cooperate through a series of technically specific data processing operations, enabling implementation of the claimed invention in a manner that is repeatable and that yields the described technical effects.
The following describes the processing flow using FIG. 11.

### Step 1:

User operates the terminal to input tourism request information.
User enters, via a graphical user interface of the terminal, a tourism image in natural language, budget information, desired travel period, departure location, desired activities, and optionally emotion-related text. The input is received as text strings and structured selections (for example, date pickers and dropdowns). The input of this step is raw user-entered data on the terminal; the output of this step is a structured request object inside the terminal's application memory, including fields such as tourism_image_text, budget_value, period_start, period_end, departure_location_text, desired_activities_list, and emotion_text.

### Step 2:

Terminal validates and transmits the tourism request information to the server. Terminal executes local validation routines to check that dates are in a valid range, that the budget is numeric and non-negative, and that mandatory fields such as departure location and travel period are present. Terminal then converts the structured request object into a serialized format, such as JSON, and establishes an HTTPS connection to the server. Terminal sends an HTTP POST request to a predefined endpoint, embedding the serialized tourism request information in the message body. The input of this step is the structured request object generated in Step 1; the output of this step is a network-transmitted payload that reaches the server as an HTTP request.

### Step 3:

Server receives and stores the tourism request information.
Server accepts the HTTP POST request via its communication interface and passes it to an application framework. Server parses the JSON payload to reconstruct an internal data structure representing the tourism request. Server generates a unique request identifier and records the tourism image, budget information, period information, departure location, desired activities, and emotion text in persistent storage, such as a relational database table. The input of this step is the serialized tourism request information received over the network; the output of this step is a stored tourism request record identified by a request_id and a corresponding in-memory representation accessible for further processing.

### Step 4:

Server analyzes the tourism request information and extracts a parameter set.
Server executes natural language processing on the tourism image and emotion text. Server tokenizes the text, applies part-of-speech tagging, and extracts entities such as geographic names, time expressions, and activity-related keywords. Server applies conversion rules that map expressions like “one night and two days” to a numerical representation of nights and days, and expressions like “near the city” to a specific region code. Server also normalizes the budget into a budget range and converts the departure location text into a standardized location code. Server then runs an emotion classification model on the emotion text to generate an emotion label. The input of this step is the in-memory tourism request record from Step 3; the output of this step is a parameter set object including at least a departure_location_code, budget_range, travel_period, travel_purpose, desired_activity_codes, and emotion_label.

### Step 5:

Server constructs a prompt sentence for the generative AI model.
Server loads a predefined prompt template from configuration and fills template placeholders with values from the parameter set and the original tourism image. Server concatenates sections such as role description, constraints, and user request to form a single prompt sentence string. Server may insert explicit formatting instructions to require that the generative AI model outputs separate sections for accommodations, transportation, and sightseeing spots. For example, server can construct a prompt sentence such as:
“You are a generative AI model specialized in domestic travel planning. Based on the following user requirements, generate an optimal tourism plan that includes accommodations, transportation, and sightseeing spots. The total cost of accommodations and transportation must be within 30,000 yen. The trip duration is one night and two days. The departure area is near a specified metropolitan region. The user wishes to enjoy hot springs in a relaxing way. Output your answer as structured text that clearly lists accommodation options, transportation options, and sightseeing spots, along with estimated prices. User tourism image: ‘I want a one-night, two-day trip near the city, with a total budget of 30,000 yen including transportation and accommodation, and I want to enjoy hot springs.’”
Server logs this prompt sentence together with the request_id. The input of this step is the parameter set and the original tourism image from Step 4; the output of this step is a prompt_sentence string stored in memory and optionally in the database.

### Step 6:

Server transmits the prompt sentence to the generative AI model and performs inference. Server prepares an API request to a generative AI model service or invokes a local inference engine. Server encodes the prompt sentence as text input and sets inference parameters such as temperature and maximum tokens. Server calls the generative AI model, which uses a transformer-based neural network to compute hidden representations of the prompt tokens and to generate output tokens forming a response. The generative AI model applies attention mechanisms across layers to combine contextual information and decodes tokens into natural-language text describing candidate accommodations, transportation options, and sightseeing spots. The input of this step is the prompt_sentence string from Step 5; the output of this step is a generated response text containing tourism candidate information in a semi-structured format.

### Step 7:

Server parses the AI-generated response and creates structured tourism candidate information.
Server analyzes the generated response text using pattern-matching and parsing rules. Server identifies segments corresponding to accommodations, transportation, and sightseeing spots, for example by detecting section headers or markers requested in the prompt. Server splits these segments into individual items and extracts attributes such as name, area, estimated price, duration, and basic schedule. Server then transforms the extracted attributes into structured objects and aggregates them into a candidate set. Server calculates preliminary total cost and total travel time for each candidate combination based on the estimated prices and times. The input of this step is the raw response text from the generative AI model obtained in Step 6; the output of this step is a tourism_candidate_info structure containing lists of accommodation_candidates, transportation_candidates, sightseeing_candidates, and associated estimates.

### Step 8:

Server verifies and enriches the tourism candidate information using external reservation systems.
Server iterates through the accommodation_candidates and transportation_candidates and invokes adapter modules to communicate with external reservation information processing devices via APIs. Server sends search queries for real accommodations with specified dates, regions, and price ranges, and receives availability, detailed pricing, and facility identifiers. Server computes similarity scores between AI-suggested items and the returned accommodations to match them, and discards unmatched or unavailable options. For transportation, server sends route and fare queries for specific origin-destination pairs and time windows, and receives real travel times, transfer counts, and fares. Server updates each candidate item with real availability flags, exact prices, and schedule details. The input of this step is the tourism_candidate_info from Step 7; the output of this step is a verified_candidate_info dataset where each candidate has been correlated with real-world reservation data and annotated with availability and precise cost.

### Step 9:

Server generates tourism plan information based on constraints and scoring.
Server constructs candidate plans by combining verified accommodation and transportation items that are both available and temporally and geographically compatible. Server computes the actual total cost for each candidate plan by summing accommodation and transportation prices, and compares the result to the budget_range from the parameter set. Server eliminates candidate plans exceeding the budget or violating period constraints. Server then computes a score for each remaining candidate plan using a scoring function that incorporates total cost, travel time, accommodation ratings, transportation comfort indicators, and alignment with the emotion_label. Server ranks the candidate plans by this score and selects one or more top-ranked plans as tourism plan information. The input of this step is the verified_candidate_info and parameter set from previous steps; the output of this step is a tourism_plan_info structure containing selected accommodations, transportation, sightseeing items, an itinerary, and cost details.

### Step 10:

Server dynamically adjusts tourism plan information based on emotional state.
Server evaluates the emotion_label and, if necessary, re-applies adjustment rules to the selected tourism_plan_info. For example, if the emotion_label indicates a desire for relaxation, server decreases allowable numbers of transfers, increases weights on accommodations with higher comfort ratings, and reduces tightly packed sightseeing schedules. Server may generate an updated prompt sentence that includes the initially generated plan and explicit emotional adjustment instructions, and may request a refined plan from the generative AI model. Server integrates the refined suggestions with availability and budget constraints, possibly re-running portions of Step 8 and Step 9 to maintain feasibility. The input of this step is the tourism_plan_info and emotion_label from earlier steps; the output of this step is an adjusted_tourism_plan_info that better reflects the user's emotional state while remaining consistent with technical constraints.

### Step 11:

Server executes bulk reservation processing for accommodations and transportation. Server extracts from the adjusted_tourism_plan_info the concrete accommodations and transportation items to be reserved, including facility identifiers, dates, and quantities. Server groups these items into a reservation batch and calls reservation endpoints on the external reservation systems via their communication interfaces. Server sends reservation request information for accommodations and transportation in a coordinated sequence and receives reservation confirmation information containing reservation numbers, payment status, and cancellation conditions. Server verifies that all critical reservations have been successfully created, and, in the event of failure, executes cancellation operations for previously created reservations if required. Server stores all reservation confirmation information in the database associated with the plan_id and request_id. The input of this step is the adjusted_tourism_plan_info from Step 10; the output of this step is a set of reservation_confirmation_records linked to the tourism plan.

### Step 12:

Server generates display data and transmits it to the terminal.
Server merges the adjusted_tourism_plan_info and the reservation_confirmation_records to form a comprehensive view of the final plan. Server converts this view into display data including a time-series itinerary, cost breakdowns, and reservation identification information. Server formats the data into a structure suitable for front-end rendering and sends it to the terminal in an HTTP response. The input of this step is the confirmed tourism plan and reservation data from Step 11; the output of this step is transmitted display_data that encodes the complete itinerary and reservation details.

### Step 13:

Terminal presents the tourism plan and user confirms or requests changes.
Terminal receives the display_data from the server and parses it to construct visual components or audio messages. Terminal displays, for example, a day-by-day schedule, accommodation cards with names and reservation IDs, and transportation segments with departure and arrival times. User reviews the presented plan and interacts with buttons or input fields to confirm acceptance, request modifications, or cancel the process. Terminal captures the user's action as a confirmation signal or modification request and sends this information back to the server. The input of this step is the display_data received from the server; the output of this step is user feedback transmitted to the server, which either finalizes the plan status or triggers further iterations of planning.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional travel planning systems require a user to manually search, select, and book accommodations, transportation, and sightseeing locations using multiple independent applications and services. Even when natural language input is accepted, typical systems treat the input merely as a query string and do not convert the input into a structured representation suitable for systematic optimization of itinerary, cost, and time constraints. As a result, substantial manual effort is required to translate the user's high-level intent into concrete and feasible reservations.

Furthermore, in many existing systems, a generative artificial intelligence model, if used at all, is invoked in an ad hoc manner, without a dedicated mechanism to programmatically construct a prompt sentence that reflects normalized travel conditions and user constraints. This leads to unstable output formats, difficulty in reliably parsing generated content, and a lack of deterministic integration between generated plans and downstream reservation interfaces. In addition, conventional architectures do not tightly couple the generative artificial intelligence output with automated, batch interaction with heterogeneous external reservation systems, thereby leaving the user to manually re-enter or confirm information across different platforms.
Also, existing systems generally do not treat user emotion information as a first-class input for controlling the behavior of the planning engine. Emotion-related data, when considered, is often only used for superficial recommendations and is not computationally integrated into the generation of prompt sentences for a generative artificial intelligence model. This results in travel plans that may technically satisfy the user's constraints but do not reflect the user's psychological state or desired experiential quality.
From a computer technology perspective, there is thus a need for an improved information processing architecture that: (i) converts unstructured, multi-modal tourism-related preference information into a structured, machine-usable representation; (ii) programmatically generates a stable, condition-rich prompt sentence for a generative artificial intelligence model; (iii) enforces a predictable output structure for the generated tourism plan that can be parsed and mapped to external reservation interfaces; and (iv) automatically performs coordinated, batch reservations via multiple external reservation apparatuses, while allowing iterative refinement of the plan. Such an architecture should improve the functioning of the computer system as a whole by reducing redundant user input, decreasing parsing and integration errors, and enabling the processor to execute a more efficient, end-to-end pipeline from user intent to confirmed itinerary.

The specific processing by the specific processing unit 290 of the data processing device 12 in Application Example 1 is realized by the following means.

The present invention provides a server comprising a processor configured to acquire tourism-related preference information of a user from a terminal device as voice input or character input and convert the tourism-related preference information into structured information; analyze, based on the structured information, tourism planning conditions including travel conditions, cost conditions, and time conditions; generate, by using the analyzed tourism planning conditions, a prompt sentence that explicitly describes the tourism planning conditions and an output specification for a generative artificial intelligence model; provide the prompt sentence as input to the generative artificial intelligence model and cause the generative artificial intelligence model to generate a tourism plan including at least an accommodation target, a movement target, and a sightseeing target in a predetermined, machine-parseable format; extract, from the generated tourism plan, accommodation candidate information and movement candidate information and convert the accommodation candidate information and the movement candidate information into reservation information adapted to communication interfaces of one or more external reservation apparatuses; communicate with the external reservation apparatuses based on the reservation information to collectively reserve a plurality of the accommodation targets and the movement targets; integrate itinerary information based on the generated tourism plan and reservation results; transmit the itinerary information to the terminal device for presentation; and, optionally, analyze emotion information included in the tourism-related preference information to dynamically modify content of the prompt sentence and iteratively update the tourism plan in response to modification requests from the user. This enables an improvement in computer functionality by providing an integrated, automated processing pipeline that transforms unstructured user intent into structured, generative-model-ready prompt sentences, enforces stable generation and parsing of tourism plans, and orchestrates batch reservations across heterogeneous external systems with reduced user interaction, enhanced consistency of data handling, and more efficient utilization of processing resources.

The term “tourism-related preference information” refers to information indicating a user's desires, constraints, and conditions regarding travel, including at least destination preferences, travel dates, budget ranges, activity types, and qualitative requirements such as desired atmosphere or pace of travel.

The term “terminal device” refers to an information processing device operated by a user, such as a mobile communication device, a wearable device, or a general-purpose computing device, capable of capturing user input and presenting information received from a server. The term “voice input” refers to user input in the form of an audio signal representing spoken language, which is acquired by an audio acquisition component and processed by a speech recognition function to generate text data.
The term “character input” refers to user input in the form of symbolic data such as alphanumeric characters or ideograms, which is entered by an input interface including, for example, a keyboard, a touch panel, or a handwriting recognition interface.
The term “structured information” refers to data that has been converted from unstructured or semi-structured user input into a predetermined data model, including explicit fields such as origin location, destination location, time interval, cost limit, and preference categories, which can be systematically processed by a computer program.
The term “tourism planning conditions” refers to a set of parameters used to generate a travel plan, including at least travel conditions, cost conditions, and time conditions derived from the structured information.
The term “travel conditions” refers to constraints and requirements related to movement in a travel plan, including at least departure location, arrival location, allowable travel modes, maximum travel time, and transfer preferences.
The term “cost conditions” refers to constraints and requirements related to expenditure in a travel plan, including at least a total budget, per-day budget, and optional upper or lower bounds on specific cost categories such as accommodation or transportation.
The term “time conditions” refers to constraints and requirements related to temporal aspects of a travel plan, including at least start date, end date, check-in and check-out times, departure and arrival times, and optional time windows for activities.
The term “prompt sentence” refers to a machine-generated text sequence that encodes the tourism planning conditions and instructions for a generative artificial intelligence model, including at least a description of the user's preferences, constraints, and a specification of a desired output format.
The term “generative artificial intelligence model” refers to a computational model trained on large-scale data to generate text or structured content in response to an input sequence, and that produces a tourism plan when provided with a prompt sentence.
The term “tourism plan” refers to information indicating a proposed travel itinerary, including at least an accommodation target, a movement target, and a sightseeing target, and optionally including schedule information, cost estimates, and descriptive guidance.
The term “accommodation target” refers to a lodging-related entity included in the tourism plan, such as a hotel, inn, or other lodging facility, specified at a granularity sufficient for reservation processing.
The term “movement target” refers to a transportation-related entity included in the tourism plan, such as a vehicle type, route, or specific service instance, used to move the user between locations during travel.
The term “sightseeing target” refers to a location or activity intended for visitation in the tourism plan, such as a tourist attraction, cultural site, event, or other point of interest.
The term “accommodation candidate information” refers to data extracted from the tourism plan that represents one or more possible accommodation targets, including at least location information, date information, and optional price or quality attributes.
The term “movement candidate information” refers to data extracted from the tourism plan that represents one or more possible movement targets, including at least departure and arrival locations, time information, and optional mode or cost attributes.
The term “reservation information” refers to data formatted for submission to an external reservation apparatus, derived from accommodation candidate information and movement candidate information, and including at least identification information, date and time information, and quantity information required to perform a reservation.
The term “external reservation apparatus” refers to an information processing system provided by a reservation service, such as an accommodation reservation system or a transportation reservation system, which receives reservation information through a communication interface and returns reservation results.
The term “communication interface” refers to a defined method and protocol for data exchange between the server and an external reservation apparatus, including at least message formats, parameter definitions, and transport protocols.
The term “reservation result” refers to data indicating an outcome of a reservation request sent to an external reservation apparatus, including at least success or failure status, and in case of success, confirmation identifiers and reserved resource details.
The term “itinerary information” refers to information that integrates the tourism plan and reservation results into a consistent representation of a travel schedule, including at least dates, times, locations, and confirmed accommodation and movement details.
The term “emotion information” refers to information representing a user's emotional state or preference, which is derived from user input or user behavior and is used to influence the content or style of the tourism plan.
The term “modification request” refers to user input indicating a desired change to an existing tourism plan, including at least additions, deletions, or adjustments of travel conditions, cost conditions, time conditions, or qualitative preferences.

In one embodiment, a server cooperates with one or more terminal devices operated by a user to generate, refine, and materialize a tourism plan by using a generative AI model driven by a structured prompt sentence. The server includes at least one processor, a memory storing a plurality of software modules, and communication interfaces connected via a network to the terminal devices and to external reservation apparatuses. The terminal includes at least one processor, a memory, user input hardware such as a microphone and touch panel, and an output interface such as a display or audio output.

The terminal executes an application program that guides the user to input tourism-related preference information. The user operates the terminal to input the tourism-related preference information using voice input or character input. The terminal uses audio acquisition hardware to capture the voice input and applies an automatic speech recognition function, for example a speech recognition library or a cloud-based recognition service, to convert the acquired audio into text data. The terminal uses an operating system keyboard or handwriting interface to accept the character input as text data. The terminal normalizes the text data by removing noise characters, performing language-specific tokenization, and converting relative temporal expressions such as “this weekend” into normalized tokens.
The terminal converts the normalized text data into structured information by using a local natural language processing module. The local natural language processing module is implemented as software running on the terminal processor and may use a rule-based parser, a small neural sequence tagger, or a combination thereof. The terminal maps portions of the text to defined fields such as origin location, destination preference, travel period, budget range, activity categories, and emotion indicators. For example, the terminal extracts a budget value “50,000 yen” into a numeric budget field and extracts an expression “relaxing hot spring trip” into activity and emotion-related fields. The terminal stores the structured information as a data object, for instance a set of key-value pairs or a nested record.
The terminal then transmits the structured information to the server via a secure communication channel. The server receives the structured information and stores it in a database management system executed on the server. The server uses a schema, such as relational tables or document collections, to store the structured information in association with a user identifier and a session identifier. The server executes a validation module to confirm the presence of necessary fields, to correct obvious inconsistencies, and to enrich the information using reference data such as calendars, location databases, and user profiles. The server can, for example, convert “this weekend” into concrete start and end dates by applying a date computation function based on the server clock.
The server generates a prompt sentence for a generative AI model by combining the structured information with a predefined prompt template. The server maintains prompt templates in configuration storage as parameterized text blocks. A template may define positions for travel conditions, cost conditions, time conditions, user preferences, and required output format instructions. The server inserts normalized values into the template and thus forms a coherent natural-language description that the generative AI model can interpret. The server further appends explicit format constraints such as “Output a detailed 2-day itinerary including accommodation, transportation, sightseeing, approximate costs, and schedule details.” to cause the generative AI model to output data in a structurally predictable manner.
In one concrete example, the server generates a prompt sentence such as:
“User wants to take a hot spring trip this weekend from a major metropolitan area. The budget is 50,000 yen in total, including transportation and accommodation. The user prefers a relaxing schedule with a focus on hot springs, a quiet atmosphere, and good local food, and does not want to travel more than 3 hours one way. Please propose a detailed 2-day itinerary including recommended hot spring area, specific accommodation types, suggested transportation, approximate costs, and time schedule, in a clearly structured textual format suitable for machine parsing.”
The server provides the generated prompt sentence to a generative AI model hosted on a computing platform. The generative AI model is implemented by a neural network architecture, for example a transformer-based network with multiple self-attention layers, feed-forward layers, and layer normalization components. The generative AI model has been pre-trained on large corpora of text data and optionally fine-tuned on travel-related content. The server specifies inference parameters such as maximum output length, sampling temperature, and penalty terms to control repetition and diversity. The server transmits the prompt sentence as an input sequence of tokens, where each token corresponds to a subword or word representation.
The generative AI model internally processes the token sequence by computing attention scores across token positions, applying learned weight matrices in each attention head, and propagating hidden states through stacked layers. The model decodes output tokens one by one according to probability distributions over the vocabulary, conditioned on the prompt and previously generated tokens. The output is a tourism plan in natural language, which includes at least an accommodation target, a movement target, and a sightseeing target, as well as schedule and cost descriptions. Because the server has embedded explicit formatting instructions and key field names into the prompt sentence, the generated output tends to follow a quasi-structured pattern with identifiable sections corresponding to days, accommodations, transportation segments, and activities.
The server receives the output of the generative AI model and executes a parsing module to transform the textual tourism plan into internal data structures. The parsing module includes a rule-based segmenter and pattern matcher which use anchor phrases such as “Day 1”, “Accommodation:”, “Transportation:”, and “Sightseeing:” to identify sections. The server extracts hotel names, check-in and check-out dates, transport modes, departure and arrival locations, departure and arrival times, and high-level descriptions of sightseeing spots. The server maps these elements into typed objects such as AccommodationOption, TransportOption, and ActivityRecord, each having defined attributes. The server also computes derived values, such as total travel time and total cost, by summing or aggregating the extracted attributes.
The server converts the extracted accommodation candidate information and movement candidate information into reservation information compatible with external reservation apparatuses. For this purpose, the server maintains adapter modules corresponding to different external reservation interfaces. Each adapter maps internal fields to external parameter names, handles date and time formatting, and performs normalization of location identifiers (for example, mapping city names to station codes or facility identifiers). The server constructs reservation request messages, which may be formatted in structured text according to the external reservation interface specification, and attaches user identification, number of travelers, and payment-related references obtained from secure storage.
The server communicates with the external reservation apparatuses over the network using their respective communication protocols. The server sends search and booking requests, receives availability results and confirmation data, and handles error conditions such as unavailable dates or overbooked services. The server may iterate through multiple candidate options generated by the generative AI model and select an option that meets the cost conditions, time conditions, and user preferences. The selection may be performed by a scoring algorithm that computes a weighted sum of normalized cost, travel time, user rating, and distance metrics. The server then confirms reservations and receives reservation results including confirmation identifiers and reservation terms.
The server integrates the reservation results with the generated tourism plan by updating the internal data structures. The server attaches confirmed identifiers, final prices, and actual schedule times to the corresponding AccommodationOption and TransportOption objects. The server produces itinerary information as a structured representation, for example a sequence of day-level records each containing confirmed accommodations, transportation segments, and planned activities. The server stores the itinerary information in the database and transmits a presentation-oriented version of the itinerary information to the terminal.
The terminal receives the itinerary information and renders it as visual or audio information. The terminal displays the daily schedule, accommodation details, departure and arrival times, and confirmation identifiers in a user interface optimized for readability on the device display. The terminal may also convert textual descriptions into synthesized speech for hands-free use. The user inspects the itinerary and can submit a modification request. For example, the user can request “make the plan cheaper,” “depart later on the first day,” or “add a museum visit on the second day.” The terminal captures the modification request as input and converts it into additional structured modification information. The terminal sends the modification information to the server.
The server receives the modification information and updates the structured information related to the user session. The server regenerates the prompt sentence by combining the original tourism planning conditions and the modification information. The server explicitly describes in the new prompt that the existing plan should be revised, for example by including sentences such as “Revise the existing itinerary to reduce total cost while preserving the hot spring destination and keeping travel time under 3 hours each way.” The server sends the revised prompt sentence to the generative AI model and obtains an updated tourism plan. The server re-runs the parsing, candidate extraction, reservation conversion, and external reservation communication. The server thereby iteratively updates the itinerary information. This iterative loop is driven by explicit processing steps implemented in the server and does not rely on ad hoc manual editing.
In another embodiment, the server additionally analyzes emotion information derived from the tourism-related preference information. The server implements an emotion estimation module that uses a classifier, for example a neural network that maps textual features such as sentiment indicators and intensity scores to discrete or continuous emotion labels (e.g., “stressed,” “excited,” “calm-seeking”). The server encodes the emotion labels into parameters that influence both prompt sentence generation and scoring of candidate plans. For instance, for an emotion labeled as “stressed,” the server adds explicit instructions into the prompt sentence such as “Prioritize minimal transfers and low-crowd environments,” and applies higher weights to comfort-related features in the scoring algorithm used to select between multiple accommodations or transportation options. By integrating this emotion-dependent logic into the computational pipeline, the server modifies internal control parameters of planning algorithms rather than merely changing superficial content.
From a technical perspective, this architecture improves computer functionality in several ways. The server uses structured information and prompt templates to constrain the generative AI model's output format, which reduces parsing errors and allows deterministic mapping of generative results to reservation interfaces. This structured prompt generation and parsing pipeline reduces the number of failed or ambiguous outputs, thereby lowering computational overhead associated with retries and manual corrections. The server also maintains adapter modules for external reservation apparatuses, which encapsulate protocol-specific details and allow reuse of normalized internal representations. This arrangement reduces the total volume of communication traffic and unnecessary queries, as the server can filter and rank options locally before issuing reservation requests.
The generative AI model itself may be trained or fine-tuned using a specific loss function that optimizes both linguistic coherence and structural conformity. For example, the model can be trained with a composite loss combining cross-entropy for token prediction with penalties for violating structural markers such as missing section headers or misordered segments. During training, the server or an associated training system uses gradient-based optimization, such as stochastic gradient descent or adaptive moment estimation, to update model weights. Data augmentation techniques, such as paraphrasing prompts or varying constraint descriptions, can be applied to improve generalization to diverse user inputs. This tailored training procedure yields a model whose outputs are more easily machine-parsed in the deployed system, further improving processing speed and reliability.
In addition, the server can implement caching and incremental update strategies. For example, when only part of the conditions change (such as a departure time adjustment), the server can retain previously computed plan segments and reservation results that remain compatible, and can request the generative AI model to modify only affected parts of the itinerary. The server can include in the prompt sentence explicit references to existing confirmed elements that should remain unchanged. This reduces the computational load on both the generative AI model and external reservation apparatuses, leading to improved throughput and lower network utilization.
The processing described herein is not limited to a single hardware configuration. In one variant, the server runs on a cluster of general-purpose processors with optional acceleration by graphics processing units for model inference. In another variant, part of the natural language understanding and prompt construction logic is offloaded to edge servers located near the terminal devices to reduce latency. The same data structures, including the structured information, candidate information, and itinerary information, can be transmitted between components as serialized objects over standard communication protocols.
The terminal can also support alternative forms of presentation and interaction, such as augmented reality overlays for sightseeing targets or context-aware notifications during travel. In such cases, the itinerary information can include geometric or geospatial attributes that the terminal uses to render markers on a map or a display device integrated into eyewear. This further ties the computational pipeline to control of technical devices in the physical world, beyond simple display of textual information.
In summary, the server uses specific data structures, prompt sentence generation logic, model-inference control parameters, parsing algorithms, and reservation interface adapters to implement an integrated computational pipeline from unstructured user input to a confirmed, machine-generated itinerary. The use of a generative AI model is constrained and guided by explicit prompt templates and structural requirements, and the system's design improves accuracy, speed, and reliability of travel planning beyond what manual or naive automated approaches achieve.

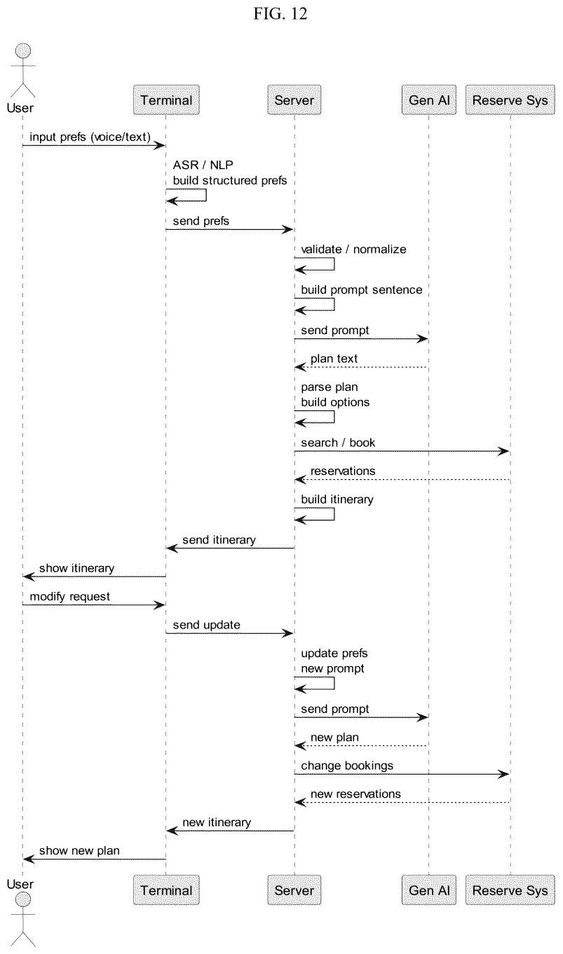

The following describes the processing flow using FIG. 12.

### Step 1:

The user provides tourism-related preference information to the terminal.
The user operates the terminal to input voice data via a microphone or character data via a touch panel or keyboard. The input is raw audio samples or text strings. The terminal receives this input and, in the case of voice, the terminal sends the audio samples to a speech recognition component and obtains a transcribed text string. The terminal outputs normalized text representing the user's tourism-related preference information.

### Step 2:

The terminal converts the user's preference text into structured information.
The terminal takes the normalized text as input and applies tokenization, part-of-speech tagging, and rule-based or model-based entity extraction to identify dates, locations, budgets, activity types, and emotion expressions. The terminal maps these extracted elements to predefined fields such as “origin_location,” “destination_preference,” “travel_period,” “budget_limit,” and “emotion_label.” By performing this mapping, the terminal generates a structured data object, for example a set of key-value pairs, as output.

### Step 3:

The terminal transmits the structured information to the server.
The terminal takes the structured data object as input, serializes it into a message format such as JSON, attaches a user identifier and session identifier, and establishes a secure communication channel to the server. The terminal sends the serialized message over the network and outputs a network request containing the structured tourism-related preference information.

### Step 4:

The server receives and validates the structured information.
The server accepts the network request as input through a communication interface, parses the serialized message, and reconstructs the structured data object. The server checks for the presence and consistency of fields such as dates, budget, and locations using validation rules. The server corrects relative expressions (for example, converting “this weekend” into concrete dates) by computing calendar values based on the server clock. The server outputs a normalized and validated structured information object.

### Step 5:

The server generates a prompt sentence for a generative AI model.
The server takes the normalized structured information as input and loads a prompt template from configuration storage. The server inserts values such as travel conditions, cost conditions, time conditions, and user preferences into placeholders in the template. The server concatenates instruction text specifying the desired output structure, such as requesting a day-by-day itinerary and explicit sections for accommodation and transportation. The server thereby produces a natural-language prompt sentence that encodes the planning conditions and formatting constraints, and outputs this prompt sentence as a text string.

### Step 6:

The server sends the prompt sentence to the generative AI model and receives a tourism plan. The server uses the prompt sentence as input to a generative AI model hosted on a computing platform. The server tokenizes the prompt sentence into subword tokens, calls an inference API of the generative AI model, and passes inference parameters such as maximum token count and sampling settings. The generative AI model processes the token sequence using its neural network layers and outputs a sequence of tokens representing a tourism plan in text form. The server decodes the tokens into a text document and outputs a generated tourism plan in natural language.

### Step 7:

The server parses the generated tourism plan into internal plan data.
The server takes the generated tourism plan text as input and applies a parsing module that searches for section headers, date markers, and label patterns such as “Day 1,” “Accommodation:,” and “Transportation:.” The server uses pattern matching and string segmentation to separate the text into day segments, accommodation descriptions, movement descriptions, and sightseeing descriptions. For each segment, the server extracts attributes such as facility names, dates, times, locations, and estimated costs. The server aggregates these attributes into typed structures, for example “AccommodationOption,” “TransportOption,” and “ActivityRecord,” and outputs a structured tourism plan object.

### Step 8:

The server derives accommodation candidate information and movement candidate information.
The server takes the structured tourism plan object as input and filters the set of extracted options according to the travel period, budget limit, and origin and destination constraints stored in the structured information. The server identifies accommodation segments and transportation segments that are feasible candidates. The server packages the extracted entities into accommodation candidate information and movement candidate information, each including identifiers, date ranges, and optional cost and rating fields. The server outputs these candidate information sets.

### Step 9:

The server converts candidate information into reservation information suitable for external reservation apparatuses.
The server takes the accommodation candidate information and movement candidate information as input and passes them to adapter modules corresponding to different external reservation systems. The server maps internal field names to external parameter names, converts date and time formats to those required by each reservation interface, and resolves location names into station codes or facility codes using lookup tables. The server generates reservation request messages that contain all required parameters for search or booking, such as number of guests, room type category, departure station, and seat class. The server outputs reservation information messages formatted per external interface specification.

### Step 10:

The server communicates with external reservation apparatuses and obtains reservation results.
The server uses the reservation information messages as input and transmits them over the network to external reservation apparatuses using their communication interfaces. The server receives availability responses and confirmation responses, parses the returned messages, and checks whether requested accommodations and transportation options are available within the budget and time conditions. The server may compute scores for multiple options using an evaluation function that combines normalized cost, travel time, and rating. The server selects the best-scoring options and issues booking requests. The server outputs reservation results including confirmation identifiers, reserved dates, and final prices.

### Step 11:

The server integrates the generated tourism plan and the reservation results into itinerary information.
The server takes the structured tourism plan object and the reservation results as input. The server associates each reservation result with the corresponding accommodation or movement segment in the plan by matching dates, locations, and labels. The server updates the plan segments with confirmation identifiers, booked times, and final costs. The server then constructs itinerary information as a chronologically ordered sequence of daily records, each containing confirmed accommodations, confirmed transportation segments, and planned activities. The server outputs the finalized itinerary information object.

### Step 12:

The server transmits the itinerary information to the terminal for presentation.
The server takes the itinerary information object as input, serializes it into a transfer format, and sends it through the communication interface to the terminal. The terminal receives the serialized itinerary information and deserializes it into internal structures suitable for display. The terminal outputs a representation of the itinerary in its local memory, ready for rendering on the display or audio output.

### Step 13:

The terminal presents the itinerary information to the user.
The terminal takes the itinerary representation as input and generates user interface elements such as lists, timelines, and detail views. The terminal arranges items by date and time, displays hotel names, addresses, departure and arrival times, and confirmation identifiers, and may generate synthesized speech representations. The terminal outputs visual frames to the display or audio signals to a speaker, thereby presenting the itinerary to the user.

### Step 14:

The user reviews the itinerary and optionally issues a modification request.
The user observes the displayed itinerary as input and determines whether changes are desired. The user operates the terminal to input a modification request via voice or character input, specifying adjustments such as budget changes, time shifts, or additional activities. The terminal receives this new input, processes it in the same manner as initial preference information to generate structured modification information, and outputs an updated structured information object.

### Step 15:

The server updates the prompt sentence and regenerates the tourism plan based on the modification request.
The server receives the updated structured information object as input, merges the modification information with existing tourism planning conditions, and generates a revised prompt sentence that explicitly instructs the generative AI model to modify the existing plan while preserving designated fixed elements. The server sends the revised prompt sentence to the generative AI model, obtains an updated tourism plan, and repeats the parsing, candidate extraction, reservation conversion, and reservation communication described in previous steps. The server outputs a revised itinerary information object, which the terminal again presents to the user.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional travel planning systems typically rely on static rule-based engines or manually curated templates to generate travel itineraries. Such systems require substantial manual configuration of destination rules, budget thresholds, and recommendation logic, and therefore do not scale well to diverse user preferences or rapidly changing travel conditions. In particular, when a user provides only abstract or vague preference information, such as a desired atmosphere or style of sightseeing, conventional systems are unable to convert this information into concrete itinerary components in a consistent and automated manner. As a result, these systems either fail to propose a plan, or produce generic proposals that require significant manual adjustment by the user.

Furthermore, conventional systems do not effectively integrate a user's emotional state into the generation of the travel plan. Even when some form of preference profile is used, it is typically static and not dynamically reflected in the underlying computational process for plan generation. This leads to itineraries that may be technically feasible within a given budget or time frame but do not align with the user's current emotional needs, such as a desire for relaxation, excitement, or low-stress travel.
From the standpoint of computer technology, conventional architectures treat the travel-planning engine, the natural language interface, and reservation processing as largely separate components. The system either presents a rigid form-based interface, or it delegates natural language interpretation entirely to a separate layer without exploiting the capabilities of modern generative models in a structured and controlled way. The computational workflow from user input to final itinerary remains fragmented: user input is collected; a fixed rules engine is invoked; results are formatted; and reservations, if supported at all, are handled in a separate, downstream module. This fragmentation causes additional network round trips, redundant parsing and formatting operations, and complicated integration logic, increasing latency and reducing robustness.
In addition, prior systems that do utilize generative models often use them only as a post-processing or cosmetic layer to “rephrase” an already-determined itinerary, rather than as a computational core that jointly reasons about budget constraints, transportation routes, accommodation options, and sightseeing locations. As a consequence, these systems do not fully exploit the model's ability to synthesize a coherent and optimized plan directly from user constraints, and still rely on complex, hand-crafted application logic running on the server. This not only increases implementation complexity but also reduces the flexibility of the system to adapt to new destinations, budget patterns, and user types.
Therefore, there is a need for an improved computer-implemented system that: (i) programmatically converts abstract preference information, resource availability information, and emotional state information into a structured prompt sentence; (ii) uses a generative AI model as an integral computational component for generating plan information under explicit resource constraints; (iii) reduces server-side algorithmic complexity by offloading multi-parameter reasoning to the generative model in a controlled manner; and (iv) automatically produces machine-usable structured information, natural language explanations, and reservation control commands in a unified processing pipeline. Such a system should improve processing efficiency, scalability, and adaptability of travel-planning computations, while providing plans that are dynamically tailored to the user's emotional state and resource constraints.

The specific processing by the specific processing unit 290 of the data processing device 12 in Example 2 is realized by the following means.

The present invention provides a server comprising a processor configured to acquire, from an information terminal operated by a user, abstract preference information related to sightseeing, resource availability information including at least budget-related information, and emotional state information of the user; to analyze the acquired information and generate a prompt sentence including at least the abstract preference information and the resource availability information, to input the prompt sentence into an external generative AI model, and to cause the generative AI model to generate plan information for an activity plan including an accommodation facility, a movement route, and a visit location within a range defined by the resource availability information; to perform, based on the plan information obtained from the generative AI model, a batch registration process of the accommodation facility and the movement route via a reservation processing apparatus; and to analyze the plan information and construct, as a natural language explanation text, contents of the activity plan including the accommodation facility, the movement route, and the visit location, and to transmit the explanation text and structured information including at least a schedule by time period, a cost allocation, and a list of visit locations to the information terminal. This enables a computer-implemented travel-planning system in which the server efficiently transforms heterogeneous user inputs into a structured prompt sentence, leverages the generative AI model as a central computational engine to jointly optimize itinerary components under explicit resource constraints, dynamically adapts the generated plan to the user's emotional state by modifying the prompt sentence, and outputs both human-readable explanations and machine-usable structured data in a single integrated processing pipeline, thereby improving processing efficiency, scalability, and responsiveness compared to conventional rule-based and template-based systems.

The term “processor” refers to a hardware-implemented computation unit, such as a central processing unit or a programmable logic device, that executes instructions to perform data acquisition, analysis, prompt generation, communication with a generative AI model, and generation of plan information according to the present invention.

The term “information terminal” refers to an electronic device operated by a user, such as a mobile device, a portable terminal, or a general-purpose computing device, that is configured to transmit user input information to the server and to present explanation text or structured information received from the server.
The term “user” refers to a human individual or an organization that operates the information terminal to request generation of an activity plan according to personal preferences, available resources, and emotional state.
The term “abstract preference information” refers to information expressing a user's desired style, atmosphere, or qualitative requirements for sightseeing or other activities, which may be provided in natural language or through selection of preference options, and which does not directly specify concrete itinerary elements such as specific locations or times.
The term “resource availability information” refers to information indicating constraints on resources that can be used for an activity plan, including at least budget-related information and optionally time-related information, transportation constraints, or accommodation constraints.
The term “budget-related information” refers to information indicating a monetary amount or range that the user is willing or able to spend for an activity plan, including amounts that may cover transportation, accommodation, meals, and other expenses.
The term “emotional state information” refers to information representing a current or desired emotional condition of the user, such as a need for relaxation, excitement, calmness, or comfort, which is used to adapt the generated activity plan.
The term “prompt sentence” refers to a textual instruction or query including at least abstract preference information and resource availability information, and optionally emotional state information, which is generated by the processor and input into a generative AI model to cause the model to generate plan information.
The term “generative AI model” refers to a machine-learned information processing model, such as a neural network-based language model, that receives a prompt sentence as input and outputs generated content including plan information for an activity plan under given constraints.
The term “plan information” refers to data generated by the generative AI model that specifies, in a structured or semi-structured manner, elements of an activity plan including at least an accommodation facility, a movement route, and a visit location, and optionally includes timing, cost allocation, and ordering of activities.
The term “activity plan” refers to a planned sequence of actions for a user, including travel, lodging, and visits to locations, which is generated based on user-provided abstract preference information, resource availability information, and emotional state information. The term “accommodation facility” refers to a place where a user can stay overnight as part of an activity plan, such as a lodging facility or other type of stay-providing facility.
The term “movement route” refers to a path or set of segments for moving a user between different locations in an activity plan, including transportation means, departure and arrival points, and optionally timing information.
The term “visit location” refers to a geographic point or area, such as a sightseeing place or point of interest, that is designated as a destination to be visited in the activity plan.
The term “reservation processing apparatus” refers to an information processing system or service that is configured to register or confirm reservations for accommodation facilities and movement routes based on reservation requests received from the server.
The term “batch registration process” refers to a process in which the processor, based on plan information, collectively issues multiple reservation requests to the reservation processing apparatus so as to register reservations for at least an accommodation facility and a movement route in a coordinated manner.
The term “natural language explanation text” refers to a text generated by the processor in a human-readable natural language that describes contents of the activity plan, including at least an accommodation facility, a movement route, and a visit location.
The term “structured information” refers to information organized according to a predefined data structure, such as fields, lists, or records, and including at least a schedule by time period, a cost allocation, and a list of visit locations corresponding to an activity plan.
The term “schedule by time period” refers to temporal arrangement information indicating planned activities divided into time segments, such as days or sub-day time slots, for execution of the activity plan.
The term “cost allocation” refers to information indicating distribution of expected costs of the activity plan across different categories, such as transportation, accommodation, meals, and other expenses.

In one embodiment, a server implements the claimed system using a general-purpose computing platform. The server uses one or more central processing units, a main memory, a non-volatile storage device, a network interface, and an operating system such as a server operating system. The server stores executable software modules including an application server module, an API gateway module, a data management module, a prompt generation module, a generative AI interface module, a plan post-processing module, and a reservation control module. The server connects to one or more external reservation processing systems via a communication network such as the Internet.

A terminal operates as an information terminal used by a user. The terminal is, for example, a smartphone, a tablet, or a personal computer including a processor, a display, an audio output device, an input device, a memory, and a communication interface. The terminal runs client software such as a web browser, a mobile application, or a desktop application. The terminal displays user interface screens that prompt the user to input abstract preference information, resource availability information, and emotional state information.
A user operates the terminal to provide input to the server. The user enters abstract preference information such as desired travel style, atmosphere, or qualitative requirements, for example “I want a relaxing 2-day trip from Tokyo to Kyoto within 30,000 yen including transport and accommodation” or “I want an exciting weekend trip from Osaka to a nearby city with focus on night entertainment.” The user specifies resource availability information such as total budget, number of days and nights, and optional constraints on transportation and accommodation categories. The user indicates emotional state information such as “tired and want to relax,” “excited and want active sightseeing,” or “traveling with children and want low-stress plan” by selecting options or entering text on the terminal.
The terminal converts the user input into a structured internal representation. The terminal stores the input as key-value pairs or records in a local memory. The terminal normalizes some fields, for example by converting textual budget expressions into numeric values and by mapping emotional labels to predefined categories. The terminal transmits the structured user input to the server by using a network communication protocol such as HTTPS.
The server receives the structured user input via the API gateway module. The server parses the received data into an internal data structure such as a record or an object held in main memory. The server validates the data to ensure that required fields are present and that values are within valid ranges. The server maps emotional state information into an internal emotional feature vector, for example by representing each emotional dimension (relaxation, excitement, social interaction, and so on) as a normalized real-valued component.
The server generates a prompt sentence to be input to a generative AI model. The server uses the prompt generation module to combine abstract preference information, resource availability information, and emotional state information into a single textual instruction. The server constructs the prompt sentence in a structured manner, with labeled sections and explicit constraints, to control the behavior of the generative AI model. For example, the server generates a prompt sentence such as:
“Please make a sightseeing plan based on user conditions.

### Conditions:.

Departure point: Tokyo
Destination: Kyoto
Itinerary: 2 days 1 night
Total budget: 30,000 yen (including transportation and accommodation)
User Preferences: Focus on a quiet, relaxed atmosphere, avoiding overly crowded tourist attractions.
User's Emotional State: Tired, relaxation is important.
   Requirements: User is tired and values relaxation.
To stay within budget, choose accommodations with realistic prices with bullet trains or express buses.
For days 1 and 2, please describe your activities for each time period: morning, afternoon, and evening.
Please take care to select times and locations that will help you avoid crowds.
Please provide an approximate cost allocation for transportation, lodging, and meals/sightseeing.
   Please answer in Japanese.”
   In another example, the server generates a prompt sentence such as:
   “Please make a sightseeing plan for 3 days and 2 nights from Osaka with a budget of 50,000 yen or less.

### Conditions:.

Departure point: Osaka
Itinerary: 3 days/2 nights
Total budget: 50,000 yen (including transportation and accommodation)
User Preferences: Enjoy the evening entertainment.
User's Emotional State: Wants an active and stimulating experience.

### Requirements.

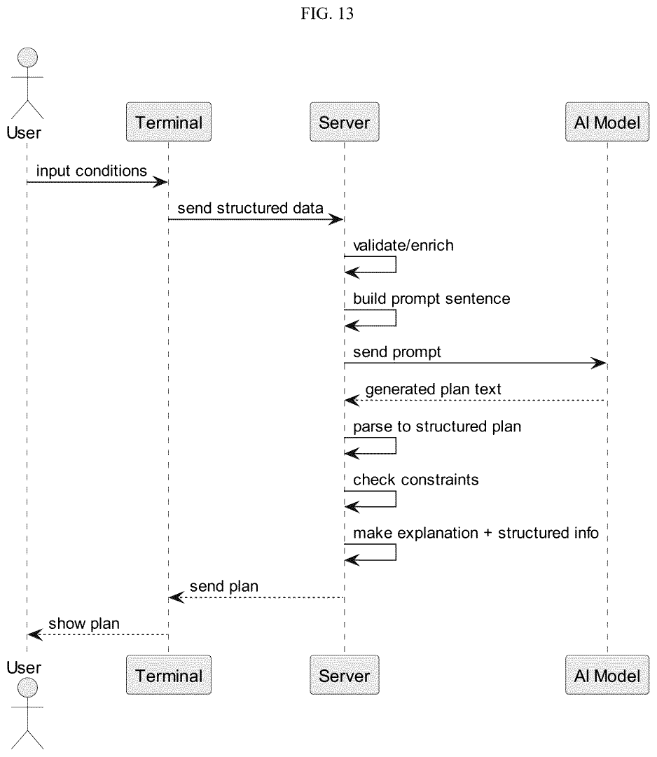

Please suggest transportation and accommodations to stay within budget.
Please describe each day, separating daytime and evening activities.
Please be specific about the sights and areas that can be enjoyed during the evening hours.
Please provide an estimate of cost allocation.
   Please answer in Japanese.”
   The server inputs the prompt sentence into a generative AI model by using the generative AI interface module. The server uses a pre-trained neural network model stored on an inference platform. The generative AI model is, for example, a transformer-based language model that includes an input embedding layer, multiple self-attention and feed-forward layers, and an output projection layer. The server tokenizes the prompt sentence into tokens according to a predefined vocabulary, converts the tokens into embeddings, and transmits the embeddings or the token sequence to the model execution environment.
   The server configures model parameters such as temperature, top-k or top-p sampling parameters, and maximum output length to balance diversity and adherence to constraints. The generative AI model computes attention scores over the input tokens and generates output tokens sequentially, where each output token is conditioned on the entire prompt sentence and previously generated tokens. The model uses learned attention weight matrices and feed-forward weights that were obtained through supervised or reinforcement learning on large-scale text corpora and domain-specific itineraries.
   In one embodiment, the server uses a fine-tuned variant of a base language model, where the fine-tuning process is performed on historical travel itineraries, budget-constrained plans, and preference-tagged examples. During fine-tuning, the model is trained to minimize a loss function such as cross-entropy between predicted tokens and ground-truth tokens, while also being conditioned on explicit budget and preference tags. The training process uses gradient-based optimization such as stochastic gradient descent or adaptive moment estimation. The model thereby internalizes patterns relating budget, travel duration, emotional states, and itinerary structure.
   The server receives the generated token sequence from the generative AI model and converts it back into text, obtaining plan information in natural language form. The server then executes a plan post-processing module that converts the natural language output into structured plan information. The server detects day boundaries, time periods, locations, and cost estimates by using rule-based parsing and pattern recognition. The server maps identified place names and transportation descriptions to internal identifiers or categories, thereby forming structured records representing an accommodation facility, a movement route, and visit locations.
   The server derives a schedule by time period by associating each planned activity with a date and a time segment such as morning, afternoon, or evening. The server aggregates cost descriptions into a cost allocation, summing or grouping estimated amounts for transportation, accommodation, meals, and other expenses. The server checks whether the total estimated cost remains within the budget constraints, and if necessary, the server can iteratively adjust the prompt sentence by tightening or relaxing specific constraints and re-invoking the generative AI model. In this way, the server performs a feedback loop where the prompt sentence is refined based on computed deviations from the resource availability information.
   The server generates a natural language explanation text by transforming the structured plan information into an explanation-oriented description. The server may reorder activities, insert summary sentences, and highlight important constraints such as budget adherence and emotional state alignment. The server outputs an explanation such as “The system proposes a 1-night, 2-day trip from Tokyo to Kyoto within 30,000 yen, using an off-peak train schedule and a quiet business hotel, with visits to less crowded temples in the morning and early evening.”
   The server constructs structured information including at least a schedule by time period, a cost allocation, and a list of visit locations. The server organizes this structured information in an internal data structure optimized for low-latency transfer and rendering, for example by grouping records by day and time segment. The server transmits the explanation text and the structured information to the terminal via the network interface using a compact message format to reduce communication overhead.
   The terminal presents the explanation text and structured information to the user. The terminal converts the structured information into a visual layout displaying a daily schedule, cost breakdown, and a list of visit locations with optional map links. The terminal can also output audio narration generated from the explanation text using a text-to-speech engine. The user reviews the proposed activity plan and may optionally modify preferences or budget and submit a new request.
   The server integrates with a reservation processing apparatus to perform a batch registration process for the accommodation facility and the movement route. The server uses the structured plan information to generate reservation requests, including dates, times, and categories of accommodations and transportation. By bundling multiple reservation requests into a single batch transaction, the server reduces the number of network round trips and the risk of inconsistent bookings. The server receives confirmation or error responses from the reservation processing apparatus and updates the plan information accordingly.
   The described architecture improves computer technology in several ways. The server uses the generative AI model not merely as a text generator but as a central computational engine that jointly optimizes multiple constraints. The prompt sentence is constructed with explicit structure and labels, enabling the model to internalize budget and emotional constraints as first-class inputs. This reduces the need for complex, hand-coded rules in server-side logic and allows the server to offload multi-dimensional optimization to a model that is efficiently executed on specialized hardware such as graphics processing units or tensor processing units.
   The server reduces processing complexity and latency by unifying natural language interpretation, constraint satisfaction, and itinerary generation into a single generative call followed by lightweight parsing. Conventional systems often implement separate modules for natural language understanding, rules-based planning, and formatting, each requiring separate passes over the data. The described system, by contrast, uses a structured prompt sentence and a single generative AI model invocation, thereby reducing the number of passes and the amount of intermediate data. This results in faster plan generation and lower server load. The server also improves accuracy and robustness of constraint handling. By encoding resource availability information and emotional state information directly in the prompt sentence and reinforcing these patterns through fine-tuning, the generative AI model learns to incorporate these constraints in its internal attention patterns. The server then verifies and, if necessary, corrects output through deterministic post-processing. This dual mechanism of learned constraint handling plus deterministic verification leads to fewer violations of budget and schedule constraints compared to purely rule-based or purely generative approaches. The server uses specific non-conventional processing steps in constructing and refining the prompt sentence. For example, the server encodes emotional state information as weighted descriptors and inserts them into the prompt sentence in a fixed segment labeled “user's emotional state,” ensuring that the model attends to emotional conditions in a consistent manner. The server also uses predefined templates that separate “conditions” and “requirements,” guiding the model to distinguish between hard constraints and optimization goals. This kind of structured prompt design, combined with iterative refinement based on budget constraint checking, provides a technical solution to the problem of controlling a generative model in a resource-constrained environment.
   In addition, the server employs data structures tailored for efficient mapping between natural language output and structured records. The server maintains lexicons of transportation categories, accommodation categories, and sightseeing categories. When the generative AI model outputs text containing specific keywords or patterns, the server maps these tokens to category identifiers through a deterministic procedure. This reduces ambiguity and supports direct use of plan information as control commands for external reservation systems. The technical effect is an improvement in data management and a reduction in manual intervention.
   In another embodiment, the server implements a modular generative AI model architecture in which a base language model is combined with a smaller constraint-checking model. The server passes the prompt sentence to the base model to generate a candidate plan and then evaluates the candidate using a secondary model trained to estimate budget feasibility and emotional alignment scores. The server computes a combined score and, if the score falls below a threshold, adjusts prompt parameters such as budget emphasis or emotional emphasis and regenerates a plan. This multi-model architecture provides a non-conventional algorithmic flow that improves the reliability of generated plans while maintaining computational efficiency.
   In yet another embodiment, the server applies data augmentation and domain adaptation techniques during model training. The server generates synthetic training examples in which budgets, durations, and emotional labels are systematically varied, and the model is trained to produce correspondingly adjusted plans. The training process uses a loss function that includes a penalty component for deviation from encoded budget tags and emotional tags. The server updates model weights through backpropagation and optimizes hyperparameters using validation data. The result is a generative AI model that exhibits improved generalization for unseen combinations of preferences and constraints, which directly enhances the technical capability of the system to handle diverse real-world inputs.
   The system is not limited to sightseeing applications. The server can apply the same technical framework to other domains requiring resource-constrained, preference-sensitive plans, such as event scheduling, logistics routing, or facility usage planning. In each case, the abstract preference information, resource availability information, and emotional or priority-related information are transformed into a structured prompt sentence for the generative AI model, and the resulting plan information is converted into structured data for device control or external system integration. This shows that the claimed system provides a general improvement to computer-based planning technology rather than a mere automation of a human mental process.
   Through these embodiments, the server, the terminal, and the user cooperate to implement the claimed invention. The server executes specialized algorithms and data structures to transform heterogeneous user inputs into optimized, constraint-compliant plans, while reducing processing overhead and improving scalability. The generative AI model is integrated as a controlled computational component with defined prompt structures, training procedures, and post-processing mechanisms, thereby providing concrete technical improvements in processing speed, plan accuracy, and data management within a computer system.
   The following describes the processing flow using FIG. 13.

### Step 1:

User operates the terminal to input travel conditions.
User inputs abstract preference information, resource availability information, and emotional state information via input fields and selection controls on the terminal, for example by typing “I want a relaxing 2-day trip from Tokyo to Kyoto within 30,000 yen including transport and accommodation.”
Input: Raw user interactions such as typed text, selected options, and button presses.
Output: Raw input values held in UI components of the terminal (text strings for preferences and budget, selection identifiers for dates, cities, and emotional labels).
User provides the semantic content that later becomes structured conditions for plan generation.

### Step 2:

Terminal structures and normalizes the user input.
Terminal converts the raw input values into an internal data structure such as a record or an object that contains fields for departure location, destination location, budget amount, duration, and emotional category.
Input: Raw strings and selection identifiers obtained in Step 1.
Output: A structured data object containing normalized fields, for example a budget represented as a numeric value and an emotional state represented as a category code.
Terminal applies simple data processing operations such as string trimming, numeric parsing, and mapping from selected labels (e.g., “tired”) to internal codes (e.g., EMO_RELAX=1.0).

### Step 3:

Terminal transmits the structured data to the server.
Terminal serializes the structured data object into a network message, sets communication parameters such as destination address and protocol, and sends the message to the server over a network.
Input: Structured user input data created in Step 2.
Output: A network request containing the structured user input, delivered to the server's network interface.
Terminal uses a communication stack to encode the data in a message format and to handle transmission and basic error detection.

### Step 4:

Server receives and parses the structured user input.
Server accepts the network request via a network interface, decodes the message format, and reconstructs the structured data object representing the user's preferences, resources, and emotional state.
Input: Network message containing serialized structured user input.
Output: An in-memory data structure on the server side that holds fields for abstract preference information, numerical budget, travel duration, and emotional state code.
Server performs data parsing operations, including JSON or similar decoding, and stores the decoded values in a controlled internal representation.

### Step 5:

Server validates and enriches the user input data.
Server checks that required fields are present, verifies that numerical values such as budget and number of days fall within acceptable ranges, and derives additional internal attributes such as total travel time or budget per day.
Input: Structured user input data from Step 4.
Output: A validated and enriched condition set that includes original fields plus derived values, such as normalized currency, default assumptions on transport and accommodation, and an emotional feature vector.
Server performs logical checks, range checks, and simple arithmetic operations to ensure that the downstream processing receives consistent and complete data.

### Step 6:

Server converts emotional state information into an emotional feature representation.
Server maps the emotional state code or label into a multi-dimensional feature vector in which each component corresponds to a dimension such as relaxation, excitement, social interaction, or stress avoidance.
Input: Emotional state code and labels from the enriched condition set.
Output: An emotional feature vector with numerical components that quantify the user's emotional requirements.
Server applies a predefined mapping or lookup table to translate categorical emotional states into numeric weights, and attaches this vector to the condition set for later use in prompt construction.

### Step 7:

Server constructs a structured prompt sentence for the generative AI model.
Server uses the validated and enriched condition set to generate a textual instruction that includes labeled sections such as “conditions” and “requirements,” and that embeds budget constraints, travel locations, schedule length, and emotional features in explicit form.
Input: Validated condition set including abstract preferences, numerical budget, travel duration, and emotional feature vector.
Output: A prompt sentence in natural language, for example:
“Please make a sightseeing plan based on user conditions.

### Conditions:.

Departure point: Tokyo
Destination: Kyoto
Itinerary: 2 days 1 night
Total budget: 30,000 yen (including transportation and accommodation)
User Preferences: Focus on a quiet, relaxed atmosphere, avoiding overly crowded tourist attractions.
User's Emotional State: Tired, relaxation is important.
   Requirements: User is tired and values relaxation.
To stay within budget, choose accommodations with realistic prices with bullet trains or express buses.
For days 1 and 2, please describe your activities for each time period: morning, afternoon, and evening.
Please take care to select times and locations that will help you avoid crowds.
Please provide an approximate cost allocation for transportation, lodging, and meals/sightseeing.
   Please answer in Japanese.”
   Server executes string formatting operations and template filling based on the numeric and categorical fields in the condition set to produce a coherent prompt sentence.

### Step 8:

Server prepares input tokens for the generative AI model.
Server applies a tokenizer associated with the generative AI model to convert the prompt sentence into a sequence of discrete tokens, and then encodes each token into its corresponding numerical identifier for input to the model.
Input: Prompt sentence text from Step 7.
Output: A sequence of token identifiers and, optionally, their vector embeddings to be consumed by the generative AI model.
Server performs lexical segmentation of the prompt sentence and maps each segment to an index using the model's vocabulary, preparing the data in the format required for neural network execution.

### Step 9:

Server invokes the generative AI model to generate plan information.
Server sends the sequence of token identifiers and configuration parameters such as maximum output length and sampling temperature to the generative AI model, which is implemented as a transformer-based neural network hosted on an inference platform.
Input: Tokenized prompt data and generation parameters.
Output: A sequence of output token identifiers representing the generated plan information in natural language.
Server controls the generative process by specifying numeric parameters and receives the model's output tokens after the neural network computes attention scores, applies weight matrices, and predicts successive tokens.

### Step 10:

Server decodes the model output into a natural language plan description.
Server converts the output token identifiers into text using the same vocabulary mapping, concatenates the resulting text segments, and obtains a complete natural language representation of the activity plan.
Input: Output token identifiers from the generative AI model in Step 9.
Output: A natural language text describing an activity plan that includes accommodation, movement routes, and visit locations, along with timing and approximate cost information. Server applies decoding rules such as stopping at special end-of-sequence tokens and removes any technical tokens or formatting artifacts that are not part of the plan description.

### Step 11:

Server parses the natural language plan into structured plan information.
Server processes the natural language description using pattern-based parsing rules and, optionally, helper models to identify days, time segments, locations, transportation types, and cost estimates, and assigns these elements to predefined fields in a structured data model.
Input: Natural language plan description obtained in Step 10.
Output: Structured plan information that explicitly lists each day, each time period's activities, each accommodation facility, each movement route, each visit location, and associated cost components.
Server performs text segmentation, keyword matching, and regular expression-based extraction; for example, server detects lines containing “day 1 a.m.” as markers for day and time segments and extracts following nouns as visit locations.

### Step 12:

Server verifies resource constraints and refines the plan if necessary.
Server compares the total estimated cost and time derived from the structured plan information against the resource availability information from the condition set, and detects violations such as exceeding budget or time.
Input: Structured plan information from Step 11 and original resource availability information from Step 5.
Output: Either confirmed plan information that satisfies constraints or a trigger condition for prompt refinement and re-generation.
Server applies numeric aggregation of cost components, checks inequality conditions (e.g., total cost ≤budget), and, when constraints are violated, adjusts weights or wording in a new prompt sentence to emphasize the violated constraints before repeating Steps 7 through 11.

### Step 13:

Server generates a natural language explanation text for the user.
Server converts the validated structured plan information into a concise explanation that describes the overall plan, including how the budget is respected and how the emotional state is addressed, in language suitable for presentation on the terminal.
Input: Structured plan information that satisfies constraints.
Output: A user-facing explanation text that summarizes and explains the activity plan in natural language.
Server constructs sentences that describe the trip in high-level form, for example “The plan proposes a 1-night, 2-day trip from Tokyo to Kyoto within 30,000 yen, using a quiet hotel and less crowded sightseeing spots in the morning to reflect the user's desire for relaxation,” by combining pre-defined explanation templates with plan-specific data.

### Step 14:

Server constructs structured information for client-side presentation and reservation control. Server organizes the structured plan information into a presentation-friendly data structure, grouping items by day and time period, and attaching cost allocation and a list of visit locations, and also deriving reservation parameters such as check-in times and transportation departure times.
Input: Structured plan information and derived reservation parameters.
Output: A structured information package containing schedule segments, cost breakdown, location list, and reservation control data.
Server executes grouping, sorting, and field mapping operations to generate a data structure that can be efficiently used both for graphical rendering on the terminal and for automated interaction with external reservation systems.

### Step 15:

Server transmits explanation text and structured information to the terminal.
Server packages the natural language explanation text and the structured information into a response message, sets response headers and status codes, and sends the message to the terminal over the network.
Input: Explanation text from Step 13 and structured information from Step 14.
Output: A network response containing both human-readable and machine-usable plan data delivered to the terminal.
Server performs serialization of the structured data, inserts the explanation text as a separate field, and utilizes the network interface to reliably send the combined message to the terminal.

### Step 16:

Terminal renders the plan to the user and enables interaction.
Terminal receives the response message, decodes the explanation text and the structured information, and displays the schedule, cost allocation, and visit locations on the screen, optionally with interactive elements for details and reservations.
Input: Response message containing explanation text and structured plan data from Step 15.
Output: Visual or audio presentation of the plan on the terminal, and user interface elements that allow the user to accept, modify, or request regeneration of the plan.
Terminal parses the received data, binds the structured fields to UI components such as lists, tables, and map links, and may trigger text-to-speech output so that the user can understand the plan and initiate follow-up actions such as confirming reservations or adjusting preferences.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional travel planning and service recommendation systems typically treat user input as a static set of parameters that are directly mapped to predefined search queries. In such systems, a processor generally executes fixed search logic over databases of accommodations, transportation options, and destinations, and then applies simple filtering based on budget and dates. These approaches exhibit several technical limitations when deployed on modern information processing infrastructures.
First, existing systems are not architected to transform heterogeneous user inputs (including natural-language text, voice, image, and sensor data) into a unified internal representation that can be consumed efficiently by advanced machine-learning components such as generative AI models. As a result, the systems cannot fully exploit generative models and must rely on rigid rule-based engines. This leads to inefficient utilization of computing resources because the processor repeatedly executes ad-hoc parsing and manual composition logic, and network communication with external services is performed in a fragmented, redundant manner.
Second, in many conventional architectures, emotional state information of the user, if used at all, is processed as an afterthought. Emotion data is typically applied only at the presentation layer, for example by altering the display order of results on a client device. The core constraint parameters (budget, time window, and preference weighting) used by the back-end search and optimization algorithms are not recalibrated in response to emotion analysis. Consequently, the processor executes search and optimization computations on constraint sets that do not reflect the user's real-time state, causing suboptimal planning results and unnecessary recomputation when the user repeatedly rejects unsuitable plans.
Third, prior systems lack a standardized, machine-interpretable interface between the constraint-normalization layer and the AI-planning layer. Generative AI models are either invoked in an ad-hoc fashion with incomplete context or are not invoked at all. There is no systematic mechanism in which a processor generates a structured, context-rich prompt sentence that embeds normalized and emotion-adjusted constraints, candidate elements from internal and external data sources, and environment information. Without such a mechanism, the generative AI model must infer missing constraints implicitly, leading to unstable outputs, increased token usage, and inefficient use of computational resources in network-based AI services.
Fourth, conventional systems do not provide an integrated, transaction-safe workflow that links AI-generated plan information to batch reservation processing and iterative refinement. Often, once a plan is generated, reservation operations are performed manually or in loosely coupled subsystems. This creates technical issues such as duplicated reservation requests, inconsistent state across databases, and increased latency due to repeated human-in-the-loop interactions. The absence of an integrated feedback loop means that the processor cannot systematically regenerate prompt sentences and plans in response to structured user modification requests, and must instead restart the planning process from scratch.
Fifth, many existing systems do not take advantage of virtual space generation techniques as a first-class computational component in the planning pipeline. Virtual experiences, if provided, are typically pre-rendered and not dynamically generated from the same plan data used by the reservation logic. This architectural separation causes redundant storage and rendering computations, and prevents the processor from reusing internal plan representations to drive both data-centric operations (such as reservations) and content-centric operations (such as virtual tours).
Accordingly, there is a need for an improved information processing architecture in which a processor (i) unifies and normalizes diverse user inputs into internal constraint data, (ii) dynamically adjusts such constraints based on emotion analysis, (iii) generates structured prompt sentences for a generative AI model in a deterministic manner, (iv) integrates AI-generated plan information with batch reservation processing and iterative user feedback, and (v) reuses the same plan information to drive both plan presentation and virtual space generation. Such an architecture can reduce redundant computation, stabilize AI outputs, decrease network and storage overhead, and improve the technical efficiency and responsiveness of travel and service planning systems operating on modern computing infrastructures.
The specific processing by the specific processing unit 290 of the data processing device 12 in Application Example 2 is realized by the following means.
The present invention provides a server comprising a processor configured to acquire, from a terminal device, user information including travel preference information, cost constraint information, time constraint information, and emotional state information, and to acquire, from at least one information storage device and at least one external information providing device, environment information including location information, historical information, and candidate travel elements; to normalize the travel preference information, the cost constraint information, and the time constraint information based on the acquired environment information, to adjust at least one of the cost constraint information and the time constraint information in accordance with the emotional state information, and to acquire, as travel candidate elements, a plurality of accommodation facilities, movement routes, and visit locations from the at least one information storage device and the at least one external information providing device; to generate, on the basis of the normalized and adjusted constraint information, the travel candidate elements, and the emotional state information, a prompt sentence in a natural language for input to a generative AI model, to input the prompt sentence to the generative AI model, and to obtain, from the generative AI model, plan information including optimal travel components and itinerary proposals selected from among the accommodation facilities, the movement routes, and the visit locations; to execute, for selected ones of the accommodation facilities and the movement routes included in the plan information, a batch reservation process via a reservation processing device, to associate a reservation result of the batch reservation process with the plan information, and to store the associated information in the at least one information storage device; and to transmit the plan information and the reservation result to the terminal device, to receive, via the terminal device, at least one of a confirmation input and a modification request input from a user, and to perform an iterative process including regeneration of the prompt sentence and regeneration of the plan information in accordance with the modification request input. This enables the server to implement a technically improved planning pipeline in which heterogeneous user inputs are converted into normalized and emotion-adjusted constraints, in which a generative AI model is driven by structured prompt sentences that embed such constraints and candidate elements, and in which AI-generated plan information is consistently coupled with batch reservation processing, iterative refinement, and virtual experience generation, thereby reducing redundant computation, stabilizing AI inference, improving resource utilization in networked computing environments, and enhancing the responsiveness and reliability of travel planning operations executed by the processor.

The term “user information” refers to information provided directly or indirectly by the user, including at least travel preference information, cost constraint information, time constraint information, and emotional state information, which is used as input for travel planning and related processing.

The term “travel preference information” refers to information indicating desired characteristics of a travel plan, including at least intended destinations, types of activities, preferred styles of travel, and qualitative requirements such as relaxation or adventure.
The term “cost constraint information” refers to information indicating monetary limitations applicable to a travel plan, including at least maximum total budget, budget allocation between transportation and accommodation, and any additional cost restrictions specified by the user or inferred by the system.
The term “time constraint information” refers to information indicating temporal limitations applicable to a travel plan, including at least travel dates, duration of stay, allowable travel time between locations, and deadlines for arrival or completion of activities.
The term “emotional state information” refers to information representing a psychological or affective condition of the user, including at least indications such as relaxed, stressed, tired, excited, in a hurry, or having a special occasion, which is obtained from explicit user input or from analysis of audio, image, or text data related to the user.
The term “environment information” refers to information related to external conditions and context of the travel planning, including at least location information, historical information, and candidate travel elements obtained from one or more information storage devices and one or more external information providing devices.
The term “location information” refers to information indicating a geographic position, including at least coordinates, place names, regions, or areas relevant to the user, the candidate travel elements, or the planned travel route.
The term “historical information” refers to information collected from past interactions or records, including at least previous travel plans, past reservations, prior user selections, and usage logs, which can be used to influence current planning and recommendation.
The term “candidate travel elements” refers to potential components of a travel plan that can be combined into a complete itinerary, including at least accommodation facilities, movement routes, and visit locations obtained from internal storage or external services.
The term “accommodation facilities” refers to lodging-related travel elements, including at least hotels, inns, hostels, rental properties, or other stay facilities that can be reserved as part of a travel plan.
The term “movement routes” refers to travel-related paths or connections between locations, including at least transportation segments, transfer paths, walking routes, and any other routes defining how the user moves between points in a travel itinerary.
The term “visit locations” refers to destinations or points of interest included in a travel plan, including at least tourist attractions, landmarks, commercial areas, natural sites, or other places that the user may visit.
The term “information storage device” refers to any storage apparatus or system configured to store digital data, including at least databases, storage servers, or other archival resources containing environment information or plan information.
The term “external information providing device” refers to any remote system or service accessible through a communication network and configured to provide data relevant to travel planning, including at least map services, reservation services, and content services. The term “constraint information” refers to one or more limitations or conditions applied to the generation of a travel plan, including at least the normalized and optionally adjusted cost constraint information and time constraint information derived from user information and environment information.
The term “normalize” refers to processing that converts heterogeneous or unstructured input data into a standardized internal representation, including at least conversion of natural-language expressions of budget or time into structured numerical or symbolic constraint data.
The term “adjust” refers to processing that modifies existing constraint information in accordance with additional factors, including at least modification of cost constraint information or time constraint information based on emotional state information.
The term “generative AI model” refers to a machine-implemented information processing model configured to generate data or content from input information, including at least a model based on machine learning or deep learning that, when provided with a prompt sentence, outputs plan information such as recommended travel components and itinerary proposals.
The term “prompt sentence” refers to a natural-language expression generated by the processor that encodes normalized and adjusted constraint information, candidate travel elements, and emotional state information, and that is supplied as input to the generative AI model to cause the generative AI model to output plan information.
The term “plan information” refers to data representing a proposed travel plan, including at least selected accommodation facilities, selected movement routes, selected visit locations, and itinerary proposals describing a temporal arrangement of such elements.
The term “itinerary proposals” refers to schedule-related components of the plan information, including at least visit sequences, time slots, estimated arrival and departure times, and ordering of activities over a defined travel period.
The term “reservation processing device” refers to any hardware or software system configured to perform reservation-related operations with external reservation services, including at least interfaces to booking systems for accommodation facilities and movement routes.
The term “batch reservation process” refers to processing in which reservation requests for a plurality of travel components, including at least accommodation facilities and movement routes, are collectively executed within a unified operation, such that reservation results for the plurality of components are obtained and can be associated with corresponding plan information.
The term “reservation result” refers to information returned from a reservation processing device or external reservation service, including at least confirmation identifiers, reservation statuses, booked dates, and financial details associated with reserved travel components.
The term “confirmation input” refers to input received from the user via the terminal device indicating acceptance or approval of at least part of the plan information or reservation result. The term “modification request input” refers to input received from the user via the terminal device indicating a request to change at least part of the plan information, including at least changes to constraints, preferences, or selection of specific travel components.
The term “iterative process” refers to processing in which the processor repeatedly performs at least prompt sentence generation, generative AI model invocation, and plan information regeneration in response to modification request inputs, thereby updating the travel plan until a termination condition such as user confirmation is satisfied.
The term “emotion analysis unit” refers to a functional component, implemented in hardware, software, or a combination thereof, configured to analyze at least one of audio information, image information, and character information in order to determine or classify an emotional state of the user.
The term “preference parameter” refers to one or more numerical or symbolic indicators representing user preferences such as relaxation orientation, activity orientation, or high added-value orientation, which are used by the processor to influence generation of the prompt sentence and subsequent plan information.
The term “virtual space generation unit” refers to a functional component, implemented in hardware, software, or a combination thereof, configured to generate virtual experience content, including at least three-dimensional or immersive representations of visit locations, on the basis of plan information.
The term “virtual experience content” refers to digital content that enables the user to perceive or simulate a travel experience in a virtual space, including at least rendered scenes, interactive environments, or guided views of visit locations corresponding to elements in the plan information.

In one embodiment, a server executes a travel planning system configured in accordance with the above claims. The server comprises at least one processor, a memory storing program instructions and data structures, a network interface, and one or more storage devices that store environment information and plan information. The server connects, via a communication network, to at least one terminal operated by a user, to at least one external information providing device such as a map information service or a reservation service, and to at least one computing system providing a generative AI model.

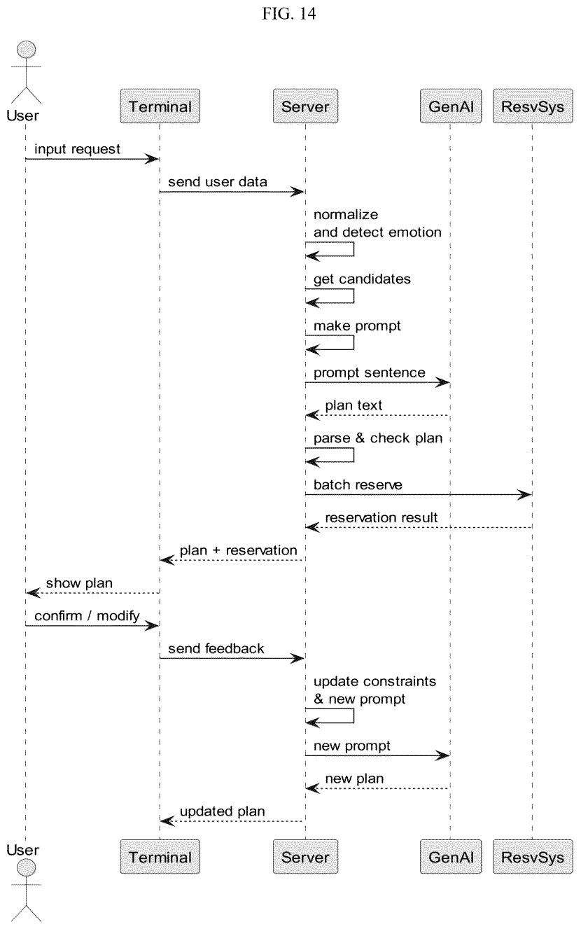

The terminal comprises at least one processor, a memory, a display unit, an audio input/output unit such as a microphone and speaker, a position detection unit such as a GPS module, and a network interface. The terminal executes an application program (for example, a mobile application or a web browser application) that provides a user interface for inputting user information and presenting plan information. The user operates the terminal by text input, touch input, voice input, and, in some embodiments, image or video capture.
The server stores, in the memory, program modules including at least a user information acquisition module, a normalization and adjustment module, an emotion analysis module, a candidate retrieval module, a prompt generation module, a generative AI interface module, a plan post-processing module, a reservation processing module, and a presentation control module. The server stores, in storage devices, structured environment information such as accommodation records, transportation route records, visit location records, historical usage logs, and parameter tables defining constraint adjustment rules.
The server receives, from the terminal, user information including at least travel preference information, cost constraint information, time constraint information, and emotional state information. The terminal may transmit this user information as a structured message, for example in a key-value representation, where fields such as “destination_text,” “budget_text,” “date_text,” “emotion_hint,” “user_location,” and “history_id” are included. The terminal may convert voice input into text by using a speech recognition library or service executed locally or remotely, and may attach the original audio data for further emotion analysis.
The server performs normalization processing on the travel preference information, the cost constraint information, and the time constraint information. The server uses a natural-language processing library, such as a sequence-to-sequence language model or a transformer-based encoder model, to parse free-form text into structured constraint data. For example, when the user inputs “I want to visit Kyoto for one night and two days with a total budget of 30,000 yen including transport and lodging,” the server converts this text into internal fields such as destination=Kyoto, trip_duration_days=2, nights=1, budget_total=30000, budget_currency=JPY, budget_scope=“transport_and_lodging.” The server stores such normalized constraint data as records in a constraint table in the storage device, indexed by a request identifier.
The server executes an emotion analysis module to determine an emotional state of the user. In one embodiment, the server uses an emotion analysis unit comprising a neural network model with a transformer-based text encoder and a convolutional or recurrent network for audio features. The server converts audio into a time-frequency representation such as a mel-spectrogram and feeds this representation, together with tokenized text, into the emotion analysis model. The model outputs an emotion vector representing probabilities for labels such as “relaxed,” “stressed,” “excited,” “tired,” “in_a_hurry,” and “special_occasion.” The server stores the emotion vector as emotional state information associated with the user information.
The server adjusts at least one of the cost constraint information and the time constraint information based on the emotional state information. To execute this processing, the server uses a rule table or parametric function that maps emotion labels to adjustment coefficients. For example, when the emotional state indicates “special_occasion,” the server multiplies a budget limit by a factor greater than 1.0 and sets a preference parameter that increases weighting of high-added-value travel elements. When the emotional state indicates “in_a_hurry,” the server decreases permissible movement time between locations and increases the weight applied to route duration in subsequent optimization. By storing both original and adjusted constraint values, the server can track how emotional state influences the constraints and can later compute gradients or statistics for system tuning.
The server retrieves candidate travel elements from at least one information storage device and at least one external information providing device. The server executes database queries over internal tables that store accommodation data (such as identifiers, categories, price ranges, locations, ratings, and capacity), transportation data (such as route identifiers, departure and arrival locations, travel times, and fares), and visit location data (such as attraction type, opening hours, entrance fees, and coordinates). The server also sends requests to external map services to obtain estimated travel times between candidate locations, and to external reservation services to obtain availability and updated prices. The server aggregates this data into a candidate set for each category (accommodation facilities, movement routes, and visit locations) that respects coarse constraints such as destination region and date range. The server generates a prompt sentence for a generative AI model on the basis of the normalized and adjusted constraint information, the emotional state information, and the candidate travel elements. The server stores constraints and candidates in an internal hierarchical data structure, and then executes the prompt generation module to render this structure into a natural-language description. The server uses templates that integrate numeric values, categorical preferences, and brief descriptions of candidate options. For example, when the user requires a one-night, two-day trip to Kyoto with a 30,000-yen budget and an “excited” emotional state, the server may generate a prompt sentence such as:
“The user wants a one-night, two-day trip to Kyoto with a total budget of 30,000 yen including transport and lodging. The user feels excited and prefers an adventurous experience. Based on the following candidate hotels, transport options, and sightseeing spots, propose an optimal travel plan with a detailed itinerary and explanation, while satisfying the budget and time constraints.”
The server may also generate prompt sentences for other use cases. When the user requests pizza delivery, the server may generate a prompt sentence such as:
“The user is near the central station and wants pizza delivered within 30 minutes. The budget is 2000 yen including delivery. Consider the following candidate restaurants and current promotions, and propose the optimal restaurant and menu to satisfy the user's request.”
When the user indicates a special anniversary in a city, the server may generate a prompt sentence such as:
“The user will spend one night and two days in the city for a special anniversary and is willing to exceed the typical budget for a memorable experience. Propose a premium travel plan including luxury lodging, a special dinner, and romantic sightseeing spots.”
The server transmits the prompt sentence to the generative AI model through a network interface. In one embodiment, the generative AI model is a transformer-based language model deployed on a remote computing system. In another embodiment, the generative AI model is executed on a graphics processing unit attached to the server. The generative AI model consists of multiple self-attention layers, feed-forward layers, and embedding layers, and is trained on large-scale text data including travel descriptions and itinerary examples. The server encodes the prompt sentence into a token sequence, supplies the sequence to the generative AI model, and specifies generation parameters such as maximum output length, temperature, and decoding strategy (e.g., beam search or top-k sampling).
The generative AI model outputs a text sequence representing plan information. The server parses this text sequence to extract structured data elements such as selected accommodation identifiers, selected movement routes, selected visit locations, scheduled times, cost estimates, and textual explanations. The server uses a post-processing module to map names or descriptions in the generated text to internal identifiers stored in the environment information. This mapping may rely on fuzzy matching, embedding similarity, or rule-based normalization. The server then composes a plan record, which includes travel components and itinerary proposals, and stores this record in a plan information table in the storage device.
The server executes additional technical processing to validate and optimize the plan information. The server recalculates travel times using the map information service to verify that proposed transitions between visit locations conform to the time constraints. The server compares the sum of estimated costs of selected travel components against the adjusted budget, and may adjust or flag components that exceed the budget. The server may perform a local optimization procedure, such as a constrained shortest-path algorithm or a mixed-integer programming relaxation, to reorder or prune visit locations while preserving the qualitative structure of the generative AI model output. By combining generative output with algorithmic optimization, the server reduces errors and improves computational efficiency, since the generative AI model does not need to explicitly search all combinations of travel elements.
The server performs batch reservation processing by sending reservation requests for selected accommodation facilities and movement routes to a reservation processing device. The server aggregates reservation parameters, such as dates, number of guests, selected room types, and seat classes, into a single reservation instruction set and transmits this set via an application programming interface. The reservation processing device communicates with external reservation services, returns reservation confirmation identifiers, and indicates success or failure. The server associates the reservation results with the corresponding plan information and stores them in the storage device. By batching reservation operations, the server reduces the number of network transactions, thereby decreasing communication load and latency and improving the reliability of consistent plan execution.
The terminal receives the plan information and the reservation result from the server. The terminal displays to the user a structured itinerary, including a timeline view, a cost breakdown view, and explanatory text describing selection reasons (for example, “this hotel was selected because it fits the budget and is close to the selected sightseeing spots” or “this restaurant was selected because it meets the 30-minute delivery constraint and matches past preferences”). The terminal may further present a virtual space representation by invoking a virtual space generation unit. For example, the terminal may execute a three-dimensional rendering engine to present a walkthrough of selected visit locations, using coordinates and metadata from the plan information to generate scenes on a head-mounted display. This integration of plan data with rendering parameters avoids redundant modeling steps and ensures consistency between the virtual experience and the actual reserved plan.
The user can confirm or modify the plan by interacting with the terminal. When the user issues a modification request, such as “make it cheaper,” “add more adventure,” or “shorten travel time,” the terminal sends the modified constraints and the reference to the existing plan information back to the server. The server updates the internal constraint records and preference parameters, and generates a new prompt sentence that explicitly describes both the previous plan and the modification request. For example, the server may generate a prompt sentence such as:
“The previous plan is too expensive for the user. Keeping the same dates and destination, propose a similar itinerary with a total budget reduced by 20%, while preserving as many key attractions as possible.”
The server transmits this updated prompt sentence to the generative AI model, receives updated plan information, and re-executes the post-processing and validation described above. By iteratively regenerating prompt sentences and plan information based on structured modification requests, the server avoids restarting the entire pipeline with completely unstructured input. This design reduces computational overhead, stabilizes the behavior of the generative AI model by providing more complete context, and shortens response time compared to naive re-planning approaches.
From a technical perspective, the described architecture improves computer technology in several ways. The server defines specific intermediate data structures (normalized constraint records, emotion vectors, candidate element sets, and plan records) that separate parsing, constraint adjustment, generative reasoning, and transactional reservation processing. This separation allows the processor to optimize each stage independently. For example, normalization and emotion adjustment can be cached and reused across multiple generative prompts, reducing repeated computation when the user explores multiple plan variants. The server uses emotion-aware constraint adjustment to reduce the number of plan generations needed to satisfy the user, thereby decreasing the number of generative AI model invocations and network calls to external services. This leads to improved computation efficiency and reduced communication bandwidth usage. Because the server enforces constraint consistency by numeric checks and optimization algorithms after receiving the generative AI model output, the system can operate with lower sampling temperatures and smaller beam widths, reducing inference time without sacrificing plan quality.
The emotion analysis unit and the generative AI model are implemented as concrete neural network architectures rather than generic “AI.” The emotion analysis unit may be trained by supervised learning on labeled multimodal emotion data, using a loss function such as cross-entropy over emotion labels, and weights are updated by stochastic gradient descent with momentum or adaptive learning rate algorithms. Data augmentation techniques such as time-stretching of audio, random cropping of spectrograms, and synonym replacement in text enhance robustness. The generative AI model may be trained with a language modeling objective on domain-specific corpora, optionally fine-tuned by reinforcement learning from human feedback, where rewards favor plans satisfying explicit constraints and user satisfaction metrics. By disclosing these training and optimization methods, the implementation goes beyond abstract ideas and describes concrete machine training and parameter update procedures.
In alternative embodiments, the server may execute multiple generative AI models for different tasks. For example, a first generative AI model may be used to select high-level travel themes and coarse itineraries, while a second generative AI model may be used to refine local details such as restaurant selections or optional activities. The server may also use non-neural components, such as constraint solvers or heuristic search algorithms, to refine and verify the generative proposals. The terminal may run lightweight versions of the normalization or emotion analysis modules to reduce latency for simple queries, while still delegating complex planning and reservation tasks to the server.
The system is not limited to travel planning. In other embodiments, the same architecture can be applied to event planning, logistics routing, or on-demand service dispatching, as long as user information, constraints, and candidates can be expressed in the internal data structures and prompt sentences. In each case, the technical core remains: the server normalizes heterogeneous input, adjusts constraints based on emotion or other state information, generates structured prompt sentences for a generative AI model, validates and optimizes the model's output, and performs batch transactions with external systems. The resulting improvement in processing speed, plan accuracy, data management, and communication efficiency arises from these specific technical interactions between modules, data structures, and machine-learning models executed by the processor, and not merely from automating a human mental process.
The following describes the processing flow using FIG. 14.

### Step 1:

User operates the terminal and inputs initial requirements.
User provides natural-language input such as destination, dates, budget, and mood by typing or speaking into the terminal application. The input includes, for example, text such as “I want a one-night, two-day trip to Kyoto with a total budget of 30,000 yen including transport and lodging. I am excited and want something adventurous.” The input to this step is raw user text and/or audio. The output of this step is a set of raw input signals (text string, audio waveform, optional images, GPS coordinates, and timestamps) stored in the terminal memory.

### Step 2:

Terminal pre-processes user input and sends structured data to the server.
Terminal converts voice to text using a speech recognition component, tokenizes simple fields (such as dates or numbers) with a local parser, and attaches device metadata including GPS coordinates and device identifier. The input to this step is the raw input signals from Step 1. The terminal performs data processing that includes audio feature extraction for speech recognition, pattern matching for date and numeric expression detection, and packaging into a message structure (for example, key-value pairs). The output of this step is a structured message containing text, optional audio, location, and context data, which the terminal transmits to the server via a network interface.

### Step 3:

Server receives and validates the user information.
Server accepts the structured message through a communication endpoint, checks the presence and format of required fields (such as destination_text, budget_text, date_text), and assigns a unique request identifier. The input to this step is the structured message from the terminal. The server performs schema validation and basic error checking, and records a log entry. The output of this step is a validated user request record stored in a request table, including a request ID used to link later processing stages.

### Step 4:

Server normalizes travel preference, cost, and time information.
Server applies a natural-language parser to the text fields of the request to extract semantic slots such as destination, duration, budget amount, and budget scope. The input to this step is the validated user request record containing free-form text. The server executes data processing that includes tokenization, part-of-speech tagging, entity recognition (for places, dates, monetary values), and conversion of language expressions into numerical or categorical values. For example, the server converts “one-night, two-day trip” into nights=1 and trip_duration_days=2. The output of this step is a normalized constraint record containing structured fields for travel preference information, cost constraint information, and time constraint information.

### Step 5:

Server analyzes the emotional state of the user.
Server invokes an emotion analysis unit that processes at least one of the text and audio attached to the request. The input to this step is the raw audio data (if present), the user text, and any explicit emotion hint fields. The server computes audio features such as mel-spectrograms, tokenizes the text, and feeds these vectors into a trained neural network classifier. The classifier performs matrix multiplications, non-linear activations, and attention operations to output an emotion probability vector. The output of this step is emotional state information, for example probabilities over labels such as “excited,” “stressed,” “relaxed,” or “in a hurry,” stored in association with the request ID.

### Step 6:

Server adjusts constraint information based on the emotional state.
Server applies predefined rules or parametric functions to modify budget and time constraints using the emotional state information. The input to this step is the normalized constraint record from Step 4 and the emotional state information from Step 5. The server performs numeric computations, such as multiplying the budget by an adjustment factor or subtracting margins from allowable travel time. For example, when the emotion is “special_occasion,” the server increases the maximum budget threshold, and when the emotion is “in_a_hurry,” the server decreases maximum allowed segment travel times. The output of this step is an adjusted constraint record that includes both original and adjusted constraint values and preference parameters (e.g., relaxation orientation or adventure orientation).

### Step 7:

Server retrieves candidate travel elements from internal and external sources.
Server generates queries to internal databases and external information providers to collect accommodation facilities, movement routes, and visit locations that match coarse constraints. The input to this step is the adjusted constraint record and the destination or region information. The server executes database queries using indices on destination, date range, and price range, and sends API requests to map services to compute travel times between candidate points. The data processing includes join operations, filtering operations, and basic scoring to eliminate clearly incompatible options. The output of this step is a candidate element set, consisting of lists of accommodation candidates, movement route candidates, and visit location candidates, each annotated with attributes such as price, location, travel time, and rating.

### Step 8:

Server constructs a prompt sentence for the generative AI model.
Server converts the adjusted constraints, emotion, and candidate element summaries into a coherent natural-language description. The input to this step is the adjusted constraint record, the emotional state information, and the candidate element set. The server runs a prompt generation module that applies templates and formatting logic to embed numeric values and qualitative information into human-readable text. For example, the server may generate the following prompt sentence:
“The user wants a one-night, two-day trip to Kyoto with a total budget of 30,000 yen including transport and lodging. The user feels excited and prefers an adventurous experience. Based on the following candidate hotels, transport options, and sightseeing spots, propose an optimal travel plan with a detailed itinerary and explanation, while satisfying the budget and time constraints.”
The output of this step is a prompt sentence in natural language, stored in association with the request ID.

### Step 9:

Server calls the generative AI model using the prompt sentence.
Server sends the prompt sentence to a generative AI model deployed either locally or on a remote computing system. The input to this step is the prompt sentence string and generation parameters such as maximum output length and sampling temperature. The server encodes the prompt into tokens, transmits the tokens to the generative AI model, and waits for a response. The generative AI model performs internal matrix operations, attention computations, and non-linear transformations to predict successive output tokens that together form plan information. The output of this step is a generated text sequence describing a proposed plan, received by the server and linked to the original request ID.

### Step 10:

Server parses and structures the AI-generated plan information.
Server analyzes the generated text to extract machine-interpretable elements. The input to this step is the generated text sequence from Step 9. The server applies pattern matching, named-entity recognition, and similarity search against the candidate element set to map textual references (such as hotel names or landmark names) to internal identifiers. The server also identifies temporal expressions and cost estimates in the generated text and converts them to numeric fields. The output of this step is a structured plan record containing selected accommodation IDs, movement route IDs, visit location IDs, an itinerary schedule, and explanatory sentences.

### Step 11:

Server validates and optimizes the structured plan.
Server uses deterministic algorithms and external services to verify constraint satisfaction and improve the plan. The input to this step is the structured plan record and the adjusted constraint record. The server recalculates travel times using the map information service, recomputes the total cost by summing component prices, and compares these values to the adjusted constraints. If violations occur, the server executes optimization procedures, such as route pruning or substitution of lower-cost accommodations, performing combinatorial checks over subsets of candidate elements. The output of this step is a validated and, if necessary, optimized plan record that remains consistent with time and budget constraints while preserving the qualitative structure proposed by the generative AI model.

### Step 12:

Server performs batch reservation processing for selected components.
Server aggregates reservation parameters for the accommodation facilities and movement routes included in the validated plan. The input to this step is the validated plan record containing concrete component identifiers and dates. The server constructs a batch request message including check-in dates, check-out dates, transport departure times, and passenger counts, and sends this batch to a reservation processing device or external reservation APIs. The data processing includes serialization of reservation parameters, correlation of response messages to each component, and error handling for failed reservations. The output of this step is a reservation result set, which includes confirmation numbers, statuses, and any alternative suggestions from the reservation services, stored and associated with the plan record.

### Step 13:

Server generates a presentation package for the terminal.
Server prepares display-oriented data that can be rendered efficiently by the terminal. The input to this step is the validated plan record and the reservation result set. The server synthesizes a timeline view, aggregates cost components into a breakdown structure, and composes explanatory messages describing why each component was selected, using text snippets derived from the generative AI output and internal rules. The server may also generate parameters for virtual space content, such as coordinates and viewpoint paths for each visit location. The output of this step is a presentation package containing itinerary data, cost data, explanation text, and optional virtual content descriptors, which the server transmits to the terminal.

### Step 14:

Terminal renders the plan and collects user feedback.
Terminal receives the presentation package and translates it into user interface elements. The input to this step is the presentation package from the server. The terminal arranges itinerary items along a timeline UI, displays cost breakdowns with totals, and shows explanation sentences for user understanding. If virtual content descriptors are present, the terminal invokes a rendering engine to generate 3D scenes or panoramic views for selected visit locations. The terminal also displays input controls for acceptance or modification, such as buttons and text fields. The output of this step is user feedback data, including confirmation input or modification request input, captured as structured messages in the terminal.

### Step 15:

Terminal sends modification requests or confirmations to the server.
Terminal encodes user actions into structured messages referencing the existing plan. The input to this step is the user feedback data from Step 14. The terminal encapsulates changes (for example, “reduce total budget by 20%,” “add more adventure activities,” or “change travel dates”) in fields linked to the plan identifier and sends this message back to the server over the network. The output of this step is a feedback message arriving at the server, which either confirms the plan or specifies constraints and preferences to be updated.

### Step 16:

Server iteratively regenerates the prompt sentence and plan based on feedback.
Server processes the feedback to update constraints and regenerate a new plan when required. The input to this step is the feedback message from the terminal and the stored plan and constraint records. The server updates the adjusted constraint record by applying the user's modification, computes any new preference parameters, and generates a new prompt sentence that explicitly references the prior plan and requested changes. For example, the server may produce:
“The previous plan is too expensive. Keeping the same destination and dates, propose a similar itinerary with a total budget reduced by 20%, while preserving as many key attractions as possible.”
The server then repeats the operations of Steps 9 through 13, including calling the generative AI model, structuring and validating the new plan, and sending an updated presentation package to the terminal. The output of this step is a refined plan and associated reservation options, allowing iterative convergence to a plan that satisfies the user's constraints and preferences.
The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### SECOND EXEMPLARY EMBODIMENT

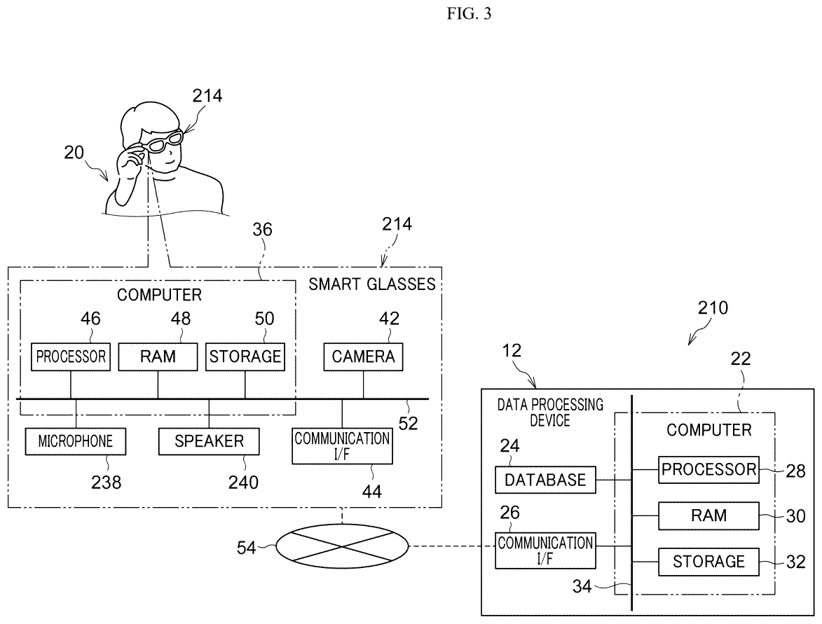

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

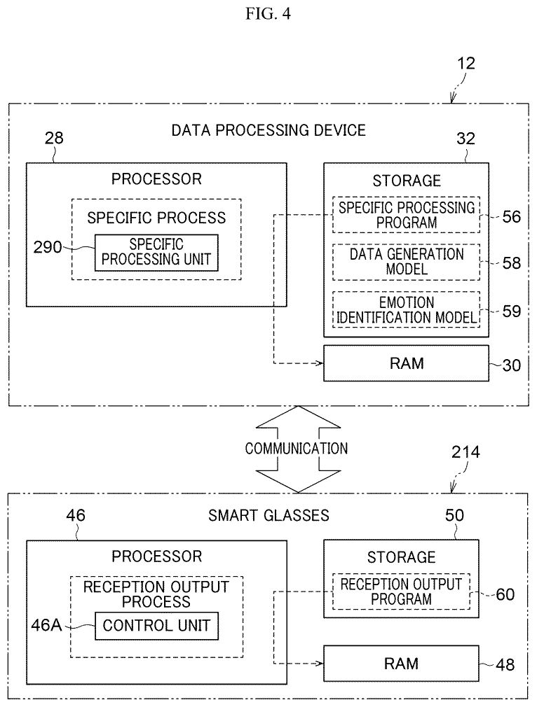

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https: //openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### THIRD EXEMPLARY EMBODIMENT

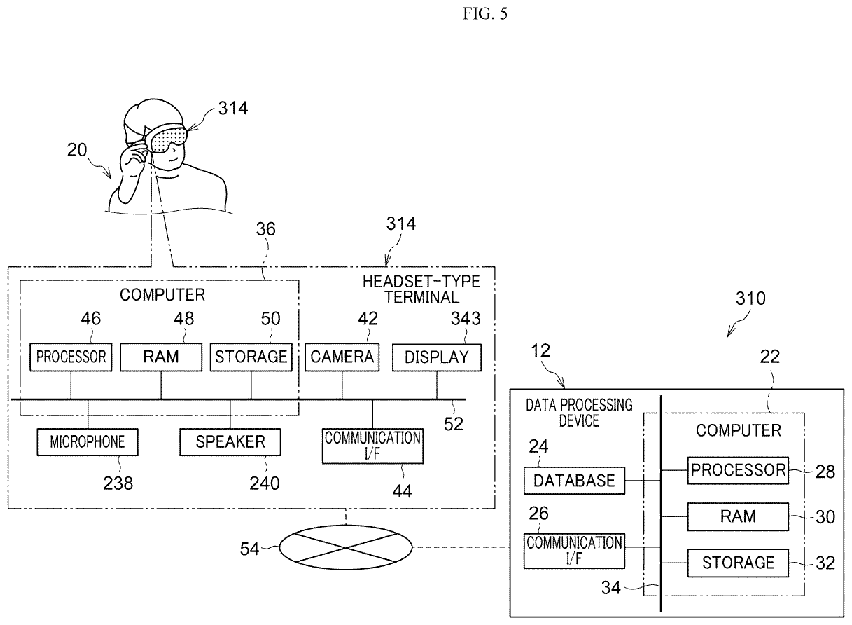

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

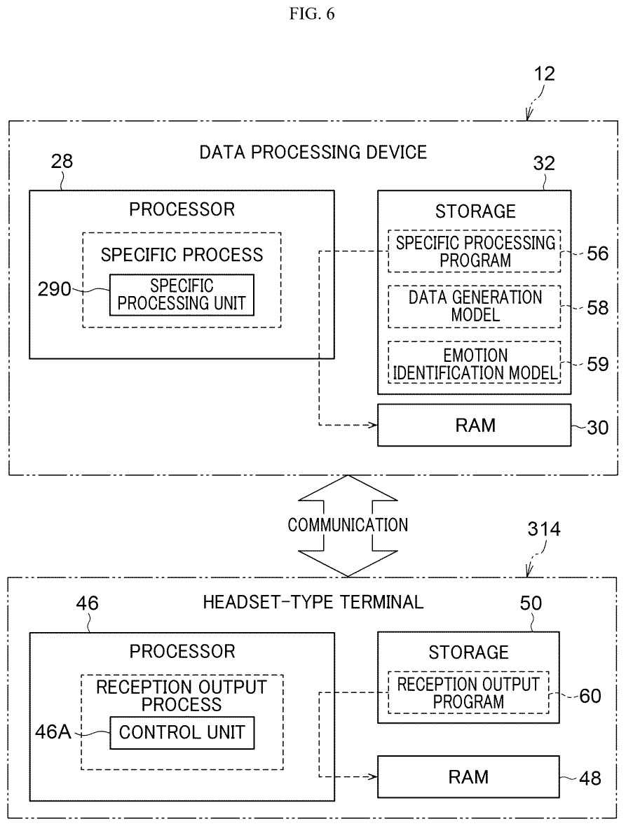

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### FOURTH EXEMPLARY EMBODIMENT

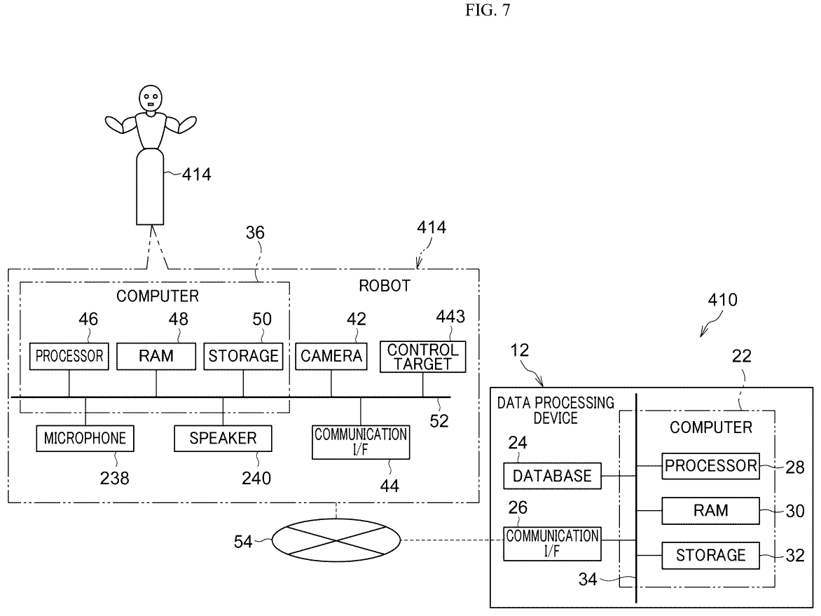

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

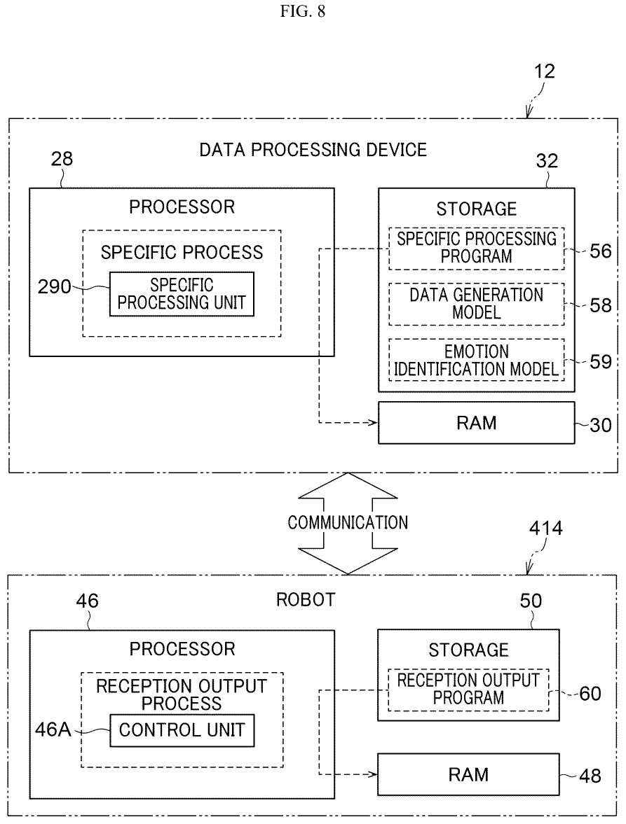

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

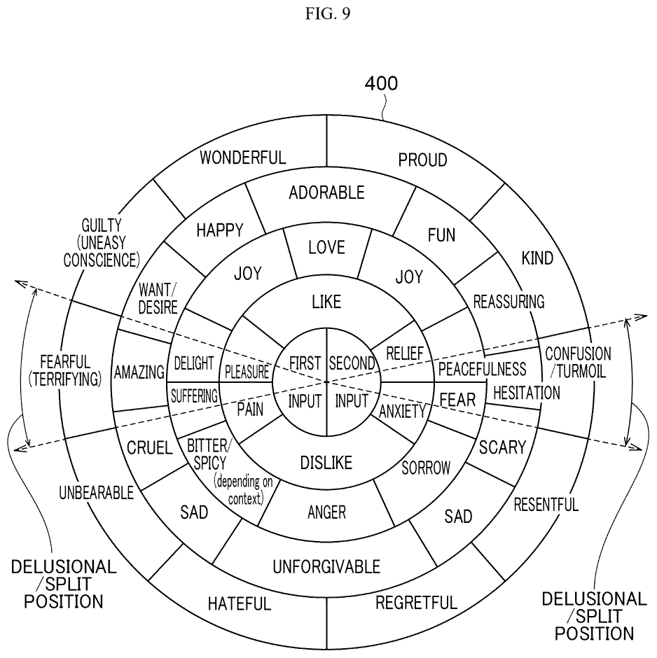

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

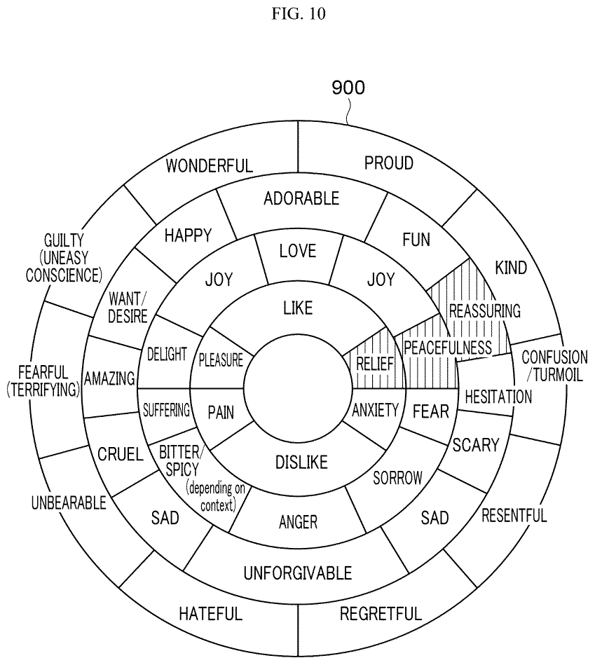

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,

wherein the processor is configured to
acquire, from an information terminal operated by a user, tourism request information including at least a tourism image, budget information, period information, departure location information, desired activity information, and emotion information,
analyze the acquired tourism request information to extract a parameter set representing at least a departure location, a budget range, a period, a travel purpose, desired activities, and an emotional state of the user, generate a prompt sentence including the parameter set and the tourism request information, and input the prompt sentence into a generative AI model to obtain tourism candidate information including at least accommodation candidates, transportation candidates, and sightseeing candidates,
perform, based on the obtained tourism candidate information, search processing for real accommodations and transportation using a communication interface provided by an external reservation information processing device, acquire vacancy information and fee information for the real accommodations and transportation, verify the tourism candidate information based on at least the budget range and the period, and generate tourism plan information based on a verification result,
transmit, for the accommodations and transportation included in the generated tourism plan information, reservation request information in bulk via the communication interface provided by the external reservation information processing device, acquire reservation confirmation information in response to the bulk transmission, and store the reservation confirmation information in association with the tourism plan information, and generate display data including at least time-series itinerary information, cost information, and reservation identification information based on the tourism plan information and the reservation confirmation information, and transmit the display data to the information terminal.

### (Supplementary 2)

The system according to supplementary 1,
wherein the processor is configured to
analyze the emotional state of the user based on the emotion information included in the tourism request information and the tourism candidate information obtained from the generative AI model, and dynamically adjust at least one of time allocation for stays, types of sightseeing candidates, comfort level of transportation candidates, and cost allocation, and regenerate the tourism plan information according to the emotional state.

### (Supplementary 3)

The system according to supplementary 1,
wherein the processor is configured to
generate at least one of visual output data and audio output data based on the generated tourism plan information and the reservation confirmation information, and provide the visual output data and the audio output data to the user via the information terminal.

### Application Example 1

### (Supplementary 1)

A system comprising a processor,
wherein the processor is configured to
acquire, from a terminal device, tourism-related preference information of a user as voice input or character input and convert the tourism-related preference information into structured information,
analyze, based on the structured information, tourism planning conditions including travel conditions, cost conditions, and time conditions, and generate a prompt sentence describing the tourism planning conditions,
provide the prompt sentence as input to a generative artificial intelligence model and cause the generative artificial intelligence model to generate a tourism plan including an accommodation target, a movement target, and a sightseeing target,
extract accommodation candidate information and movement candidate information from the generated tourism plan and convert the accommodation candidate information and the movement candidate information into reservation information adapted to a communication interface of an external reservation apparatus,
communicate with the external reservation apparatus based on the reservation information and collectively reserve a plurality of the accommodation targets and the movement targets, and
integrate itinerary information based on the generated tourism plan and a reservation result and transmit the itinerary information to the terminal device for presentation to the user.

### (Supplementary 2)

The system according to supplementary 1,
wherein the processor is configured to
analyze emotion information included in the tourism-related preference information, dynamically modify content of the prompt sentence based on the emotion information and the structured information, and adjust content of the tourism plan generated by the generative artificial intelligence model in accordance with the emotion information.

### (Supplementary 3)

The system according to supplementary 1,
wherein the processor is configured to
cause the generated tourism plan and the reservation result to be presented by the terminal device as visual information or audio information, acquire a modification request from the user as new tourism-related preference information, regenerate the prompt sentence based on the modification request, and re-input the regenerated prompt sentence to the generative artificial intelligence model to iteratively update the tourism plan.

### Example 2

### (Supplementary 1)

A system comprising a processor,
wherein the processor is configured to
acquire, from an information terminal operated by a user, abstract preference information related to sightseeing, resource availability information, and emotional state information of the user, and
analyze the acquired information and generate a prompt sentence including at least the abstract preference information and the resource availability information, input the prompt sentence into an external generative AI model, and cause the generative AI model to generate plan information for an activity plan including an accommodation facility, a movement route, and a visit location within a range of the resource availability information, and perform, based on the plan information obtained from the generative AI model, a batch registration process of the accommodation facility and the movement route via a reservation processing apparatus, and
analyze the plan information and construct, as a natural language explanation text, contents of the activity plan including the accommodation facility, the movement route, and the visit location, and transmit the explanation text to the information terminal.

### (Supplementary 2)

The system according to supplementary 1,
wherein the processor is configured to
analyze the emotional state information and, based on a result of the analysis, dynamically change contents of the prompt sentence to be input to the generative AI model, thereby adjusting the plan information of the activity plan according to the emotional state of the user.

### (Supplementary 3)

The system according to supplementary 1,
wherein the processor is configured to
generate, from the explanation text and the plan information, structured information including at least a schedule by time period, a cost allocation, and a list of visit locations, and transmit the structured information to the information terminal so that the structured information is presented visually or auditorily at the information terminal.

### Application Example 2

### (Supplementary 1)

A system comprising a processor,
wherein the processor is configured to
acquire, from a terminal device, user information including travel preference information, cost constraint information, time constraint information, and emotional state information, and to acquire, from at least one information storage device and at least one external information providing device, environment information including location information, historical information, and candidate travel elements,
normalize the travel preference information, the cost constraint information, and the time constraint information based on the acquired environment information, adjust at least one of the cost constraint information and the time constraint information in accordance with the emotional state information, and acquire, as travel candidate elements, a plurality of accommodation facilities, movement routes, and visit locations from the at least one information storage device and the at least one external information providing device, generate, on the basis of the normalized and adjusted constraint information, the travel candidate elements, and the emotional state information, a prompt sentence in a natural language for input to a generative AI model, input the prompt sentence to the generative AI model, and obtain, from the generative AI model, plan information including optimal travel components and itinerary proposals selected from among the accommodation facilities, the movement routes, and the visit locations,
execute, for selected ones of the accommodation facilities and the movement routes included in the plan information, a batch reservation process via a reservation processing device, associate a reservation result of the batch reservation process with the plan information, and store the associated information in the at least one information storage device, and
transmit the plan information and the reservation result to the terminal device, receive, via the terminal device, at least one of a confirmation input and a modification request input from the user, and perform an iterative process including regeneration of the prompt sentence and regeneration of the plan information in accordance with the modification request input.

### (Supplementary 2)

The system according to supplementary 1,
wherein the processor is configured to
analyze the emotional state of the user by using an emotion analysis unit that processes at least one of audio information, image information, and character information included in the acquired user information, dynamically change at least one of the cost constraint information and the time constraint information in accordance with an analysis result of the emotional state, and set at least one preference parameter representing at least one of relaxation orientation, activity orientation, and high added-value orientation so that the preference parameter is reflected in the prompt sentence.

### (Supplementary 3)

The system according to supplementary 1,
wherein the processor is configured to
output the plan information and the reservation result to the user in at least one of a visual form and an auditory form including a timeline itinerary display, a cost breakdown display, and an explanatory sentence indicating selection reasons, and to cause a virtual space generation unit to generate virtual experience content of at least one of the visit locations and provide the virtual experience content to the terminal device so that the travel components and the itinerary proposals included in the plan information are presented to the user.

What is claimed is:

1. A system comprising:
circuitry configured to:
receive, via a communication interface coupled to a packet-switched network, request data from a terminal device, the request data comprising at least a natural language description, a budget parameter, a period parameter, a departure location parameter, a desired activity parameter, and an emotion state parameter;
apply a natural language processing algorithm to the request data to extract a structured parameter set comprising at least a budget range, a time period, a departure location, a purpose parameter, and desired activity types, and generate a prompt sentence embedding the structured parameter set and the request data;
input the prompt sentence to a generative neural network model and receive structured candidate data comprising at least first candidate records, second candidate records, and third candidate records from the generative neural network model;
execute search processing via a standardized communication interface with an external data service to acquire availability data and fee data for candidates in the first candidate records and the second candidate records, and verify the structured candidate data against the budget range and the time period to generate plan data;
execute coordinated bulk request processing by transmitting request data for candidates in the first candidate records and the second candidate records in bulk via the standardized communication interface to the external data service, receiving confirmation data in response, and storing the confirmation data in association with the plan data; and
dynamically adjust at least one of a time allocation parameter, a candidate type parameter, a comfort level parameter, or a cost allocation parameter based on the emotion state parameter, and regenerate updated plan data incorporating the adjusted parameters.

2. The system according to claim 1, wherein the circuitry is configured to apply a named entity recognition algorithm and a semantic parsing algorithm to the natural language description to identify location entities, time expressions, activity categories, and constraint expressions, and map the identified entities and expressions to the structured parameter set.

3. The system according to claim 2, wherein the circuitry is configured to apply a constraint validation algorithm to the structured parameter set to verify that the budget range, time period, and departure location parameter are mutually consistent, and generate a clarification request for transmission to the terminal device when a constraint inconsistency is detected.

4. The system according to claim 3, wherein the circuitry is configured to generate the prompt sentence by selecting a prompt template based on the purpose parameter and desired activity types, substituting the structured parameter set into the prompt template, and appending output format specifications requiring the generative neural network model to output structured candidate records with labeled fields.

5. The system according to claim 4, wherein the circuitry is configured to parse the structured candidate data received from the generative neural network model to extract labeled field values for each record in the first candidate records, second candidate records, and third candidate records, and validate each extracted field value against a reference data format stored in the storage device.

6. The system according to claim 5, wherein the circuitry is configured to apply a cost optimization algorithm to the validated candidate records by computing a total cost estimate from fee data acquired via the standardized communication interface, comparing the total cost estimate against the budget range, and eliminating candidate records that cause the total cost estimate to exceed the budget range.

7. The system according to claim 6, wherein the circuitry is configured to rank remaining candidate records based on a preference score computed from the desired activity parameter, the emotion state parameter, and availability data, select a highest-ranked combination of candidate records, and generate the plan data from the selected combination.

8. The system according to claim 1, wherein the circuitry is configured to classify the emotion state parameter into one of a plurality of emotional state categories, select a plan adjustment strategy from a plurality of plan adjustment strategies based on the classified emotional state category, and apply the selected plan adjustment strategy to adjust the time allocation parameter and comfort level parameter of the plan data.

9. The system according to claim 8, wherein the circuitry is configured to detect a change in the emotion state parameter exceeding a state-change threshold between consecutive plan generation cycles, regenerate the prompt sentence incorporating the updated emotion state parameter, supply the regenerated prompt sentence to the generative neural network model, and generate updated candidate data reflecting the adjusted parameters.

10. The system according to claim 1, wherein the circuitry is configured to receive real-time status data from the external data service via the communication interface indicating changes in availability or fee data, detect a conflict between the real-time status data and the plan data, and regenerate the prompt sentence incorporating the conflict information to trigger generation of an alternative candidate set by the generative neural network model.

11. The system according to claim 10, wherein the circuitry is configured to apply an alternative selection algorithm to the alternative candidate set to identify a replacement that minimizes deviation from the original plan data while satisfying the budget range and time period constraints, and update the plan data with the selected replacement.

12. The system according to claim 1, wherein the circuitry is configured to receive a natural language modification request from the terminal device, apply the natural language processing algorithm to the modification request to extract updated parameter values, update the structured parameter set with the extracted parameter values, regenerate the prompt sentence, and supply the regenerated prompt sentence to the generative neural network model.

13. The system according to claim 12, wherein the circuitry is configured to store a history of prompt sentences, structured candidate data, and plan data in the storage device indexed by a session identifier, and supply stored history data as context in subsequent prompt sentence generation to maintain consistency across plan modification cycles.

14. The system according to claim 1, wherein the circuitry is configured to generate a plurality of candidate prompt sentences each encoding different subsets of the structured parameter set and the emotion state parameter, input each candidate prompt sentence to the generative neural network model to generate a plurality of candidate plan datasets, evaluate each candidate plan dataset using a satisfaction metric computed from the preference score and the budget range, and select the highest-scoring candidate plan dataset as the plan data.

15. The system according to claim 14, wherein the circuitry is configured to compute the satisfaction metric by applying a multi-objective scoring function that balances a preference alignment score, a cost efficiency score, and an emotion state alignment score, and select the candidate plan dataset with the highest combined score.

16. The system according to claim 1, wherein the circuitry is configured to generate a notification comprising confirmation data and plan data, and transmit the notification to the terminal device via the communication interface upon successful completion of the bulk request processing.

17. The system according to claim 1, wherein the circuitry is configured to detect a failure response from the external data service for a candidate in the first candidate records or the second candidate records during the bulk request processing, apply a fallback selection algorithm to identify an alternative candidate satisfying the budget range and time period constraints, and substitute the alternative candidate into the plan data prior to retransmitting the request data.

18. A system comprising:
circuitry configured to:
receive, via a communication interface coupled to a packet-switched network, request data comprising at least a natural language description, a budget parameter, a period parameter, and an emotion state parameter from a terminal device;
apply a natural language processing algorithm to extract a structured parameter set from the request data, generate a prompt sentence embedding the structured parameter set, and input the prompt sentence to a generative neural network model to receive structured candidate data;
execute search processing via an external data service to acquire availability data and fee data for the structured candidate data, verify against the budget parameter and the period parameter, and generate plan data;
execute bulk request processing transmitting requests for confirmed candidates in bulk via the external data service, receiving confirmation data, and storing the confirmation data with the plan data; and
dynamically adjust at least one of a time allocation parameter, a candidate type parameter, or a cost allocation parameter based on the emotion state parameter to regenerate updated plan data.

19. The system according to claim 18, wherein the circuitry is configured to detect a change in the emotion state parameter exceeding a state-change threshold, regenerate the prompt sentence incorporating the updated emotion state parameter, and supply the regenerated prompt sentence to the generative neural network model to generate updated candidate data.

20. A method performed by circuitry, the method comprising:
receiving, via a communication interface coupled to a packet-switched network, request data from a terminal device, the request data comprising at least a natural language description, a budget parameter, a period parameter, a departure location parameter, a desired activity parameter, and an emotion state parameter;
applying a natural language processing algorithm to the request data to extract a structured parameter set comprising at least a budget range, a time period, a departure location, a purpose parameter, and desired activity types, and generating a prompt sentence embedding the structured parameter set and the request data;
inputting the prompt sentence to a generative neural network model and receiving structured candidate data comprising at least first candidate records, second candidate records, and third candidate records from the generative neural network model;
executing search processing via a standardized communication interface with an external data service to acquire availability data and fee data for candidates in the first candidate records and the second candidate records, and verifying the structured candidate data against the budget range and the time period to generate plan data;
executing coordinated bulk request processing by transmitting request data for candidates in the first candidate records and the second candidate records in bulk via the standardized communication interface to the external data service, receiving confirmation data in response, and storing the confirmation data in association with the plan data; and
dynamically adjusting at least one of a time allocation parameter, a candidate type parameter, a comfort level parameter, or a cost allocation parameter based on the emotion state parameter, and regenerating updated plan data incorporating the adjusted parameters.
